(19) United States
(12) Patent Application Publication
(10) Pub. No.: US 2008/0291220 A1
(43) Pub. Date: Nov. 27, 2008

(54) Electronic game utilizing photographs

(75) Inventors: YuChiang Cheng, San Francisco, CA (US); Chad M. Nelson, Oakland, CA (US); David Montgomery, Half Moon Bay, CA (US); Phil Gorrow, Half Moon Bay, CA (US); David Castelnuovo, San Francisco, CA (US)

Correspondence Address: FISH & RICHARDSON P.C., PO BOX 1022, MINNEAPOLIS, MN, 55440-1022, US

(73) Assignee: World Golf Tour, Inc., San Francisco, CA (US)

(21) Appl. No.: 12/154,336

(22) Filed: May 21, 2008

Related U.S. Application Data
(60) Provisional application No. 60/939,312, filed on May 21, 2007.

(51) Int. Cl. G06T 15/00; G09G 5/00

(52) U.S. Cl. 345/632; 345/581

(57) ABSTRACT

The present disclosure includes, among other things, methods and apparatus, including computer program products, for providing an electronic game utilizing photographs.

### CROSS REFERENCE TO RELATED APPLICATIONS

This application claims priority to U.S. Provisional Application Ser. No. 60/939,312, entitled “Integrating Objects in Three-Dimensional Space into Photographs,” filed on May 21, 2007, the entire contents of which are hereby incorporated by reference.

### BACKGROUND

Electronic games and other types of simulations recreate real world environments such as baseball diamonds, race tracks, and golf courses through three dimensional (3D) computer generated graphics. However, such graphics can typically create unnatural visual artifacts such as repeating patterns which detract from the intended realism of the imagery. Some electronic games may use a photograph of an actual location as a background, such as mountains, with computer generated graphics rendered in the foreground. However, there may not be any interaction between the computer generated graphics and the terrain represented by the photograph.

### SUMMARY

In general, one aspect of the subject matter described in this specification can be embodied in a computer-implemented method that includes receiving a two-dimensional photographic image of a physical terrain and a first discrete shape associated with the image, the first discrete shape associated with a location in the image and a distance value. A virtual object moving along a trajectory in the image, where a part of the two-dimensional trajectory overlaps with the location of the first discrete shape is displayed. Some or all of the virtual object when the virtual object overlaps with the location of the first discrete shape and has a distance value greater than that of the first discrete shape is obscured. Other implementations of this aspect include corresponding systems, apparatus, and computer program products.

These and other implementations can optionally include one or more of the following features. The image is associated with a plurality of discrete shapes, including the first discrete shape and a second discrete shape, and the first discrete shape having a greater distance value than the second discrete shape. Displaying the virtual object moving along a trajectory in the image includes obscuring a part of a first discrete shape with the virtual object when the first discrete shape has a greater distance value than the virtual object and obscuring the virtual object when the virtual object has a distance value greater than a distance value of the second discrete shape. The image is associated with a plurality of mask layers, each mask layer having a discrete shape and where each mask layer is assigned a priority in a hierarchy. The first discrete shape represents the ground. The method can further include changing a display angle to display an image where the virtual object is visible. The part of the trajectory that overlaps with the first discrete shape is a landing spot. The first discrete shape is a shape of a real world object in the image. Displaying includes mapping a three-dimensional trajectory of the virtual object in relation to a model of the physical terrain to the two-dimensional trajectory.

Particular implementations of the invention can be implemented to realize one or more of the following advantages. Players are provided the experience of playing on a real course because of the integration of actual photographs of the course into the game play. Photographs can be pre-fetched based on one or more player's history to improve the performance of the game or simulation. Virtual objects are integrated at the proper location and with the proper scale into actual photographs such that the player has the impression the virtual objects were actually photographed on the course. Representations of real world objects in the photographs can be assigned characteristics similar to the characteristics that the real world objects have, such as hardness, elasticity, friction, and the ability to change or slow the trajectory of a virtual object that interacts with the real world object. The representations of real world objects can also be made to obscure the virtual object when the virtual object would be hidden behind the real world object. Creating a course terrain with attributes allows virtual objects to interact with objects in the terrain in a natural way and provide a more realistic presentation of the game to a player. A course can be manually or automatically divided into a grid of potentially varying density and a shot list can be automatically generated for the grid. Shot sequences are automatically determined based on a number of factors. Games can be replayed and replay information can be shared with other users.

The details of one or more implementations of the invention are set forth in the accompanying drawings and the description below. Other features, aspects, and advantages of the invention will become apparent from the description, the drawings, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-C illustrate an example graphical user interface for a computer golf game that incorporates photographs of an actual golf course into the game play.

FIG. 2A is a flowchart of an example technique for photographic mapping in a simulation such as an electronic game.

FIG. 2B is a flowchart of an example technique for pre-fetching photographic images for mapping in a simulation such as an electronic game.

FIG. 3A illustrates an example course grid.

FIG. 3B illustrates an example of how photograph parameters can be derived from a cell in a course grid.

FIG. 3C is an actual course photograph of a 25′6″×25′6″ cell.

FIG. 3D is an actual course photograph of a 10′3″×10′3″ cell.

FIG. 4 is a flowchart illustrating an example technique for automatically dividing a course into cells and generating a shot list.

FIG. 5A is an illustration of an example of a course terrain.

FIG. 5B1 shows an example delineation of surface types assigned to a photograph.

FIG. 5B2 is a flowchart of an example technique for assigning surface types to objects in a photograph.

FIG. 5C1 is a photograph of a golf fairway with trees.

FIG. 5C2 is a flowchart of an example technique for illustrating how the real world objects obtain collision properties.

FIG. 5D shows an example location of tree trunks and palm fronds in the trees in FIG. 5C1.

FIG. 5E is a ball trajectory of an example golf ball hitting the palm fronds of FIG. 5C1.

FIG. 5F is a ball trajectory of an example golf ball hitting a trunk of FIG. 5C1.

FIG. 5G is an overhead view of an example hazard area on a golf course.

FIG. 5H shows an example location of bushes and ground cover in the hazard area.

FIG. 5I is a photograph of an example golf hole with trees.

FIG. 5J is an example representation of the trees in the photograph.

FIG. 5K is an example representation of a virtual ball in front of the trees.

FIG. 5L is an example representation of a virtual ball's path leading behind a tree.

FIG. 5M is an example representation of a virtual ball's path leading behind a ridge.

FIG. 5N is a flow chart illustrating how a virtual object can be displayed during play.

FIG. 5O is a flow chart illustrating an example use of the attributes assigned to the real world images.

FIG. 5P is a flow chart illustrating an example method of representing the movement of a virtual object.

FIG. 6A is a flowchart illustrating an example technique for incorporating a visual representation of virtual objects into a photograph.

FIG. 6B is an illustration of an example 3D mapping.

FIGS. 7A-C are diagrams illustrating example client-server architectures.

FIG. 7D is a schematic diagram of an example client.

FIG. 7E is an overhead view of an example virtual course illustrating cells along a virtual object path.

FIG. 7F is a profile view of an example virtual object path in relation to a model of a physical terrain.

FIG. 7G is a flowchart illustrating an example technique for shot selection.

FIG. 7H is a schematic diagram of an example server.

FIG. 7I is a flowchart of an example method for replaying a simulation.

FIG. 7J is an illustration of an example swing meter.

Like reference numbers and designations in the various drawings indicate like elements.

### DETAILED DESCRIPTION

Various implementations recreate the experience of playing on a course (e.g., a golf course, a baseball diamond, a race track) utilizing digital representations of actual photographs of the course combined with computer generated two dimensional (2D) and 3D graphics, animation and effects.

Electronic games and other types of simulations typically include a virtual universe that players interact with in order to achieve one or more goals, such as shooting all of the “bad” guys or playing a hole of golf. Typical electronic game genres include role-playing, first person shooter, third person shooter, sports, racing, fighting, action, strategy, and simulation. An electronic game can incorporate a combination of two or more genres. Electronic games are commonly available for different computer platforms such as workstations, personal computers, game consoles (e.g., Sony PlayStation and PlayStation Portable, Microsoft Xbox, Nintendo GameCube, Game Boy and Wii), cellular telephones, portable media players, and other mobile devices. Electronic games can be single player or multi-player. Some multi-player games allow players connected via the Internet to interact in a common or shared virtual universe.

A virtual universe is the paradigm with which the user interacts when playing an electronic game and can include representations of virtual environments, objects, characters, and associated state information. For instance, a virtual universe can include a virtual golf course, golfers golf clubs and golf balls. A virtual universe and its virtual objects can change as users achieve goals. For example, in action games as users advance to higher game levels, typically the virtual universe is changed to model the new level and users are furnished with different virtual equipment, such as more powerful weapons.

Players typically interact with one or more virtual objects in a virtual universe, such as an avatar and virtual equipment, through a user interface. A user interface can accept input from all manner of input devices including, but not limited to, devices capable of receiving mouse input, trackball input, scroll wheel input, button presses, verbal commands, sounds, gestures, eye movements, body movements, brain waves, other types of physiological sensors, and combinations of these. A click of a mouse button, for example, might cause a virtual golf club swing and strike a virtual golf ball on a virtual golf course.

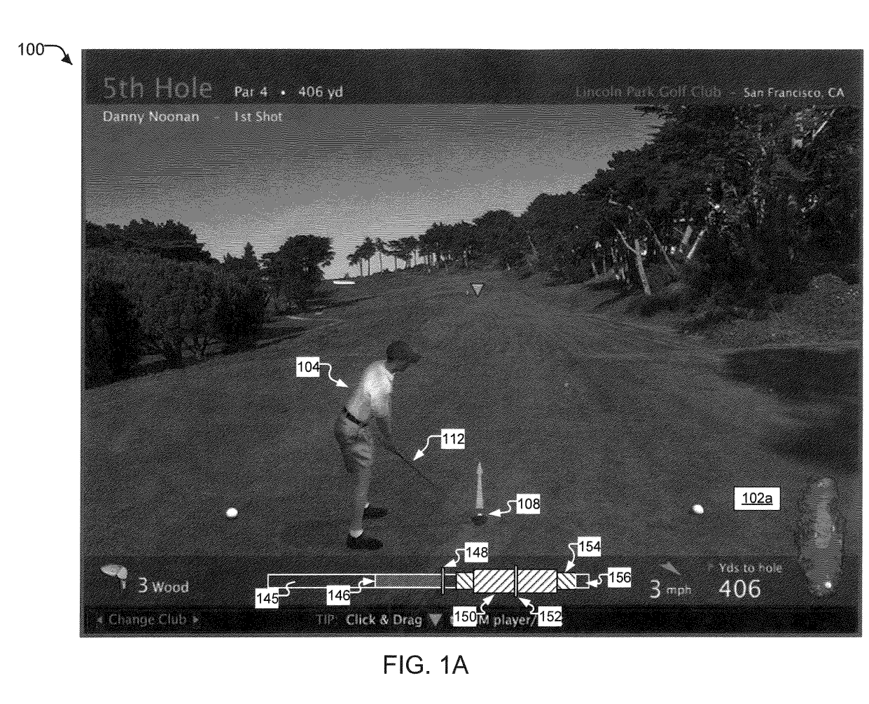

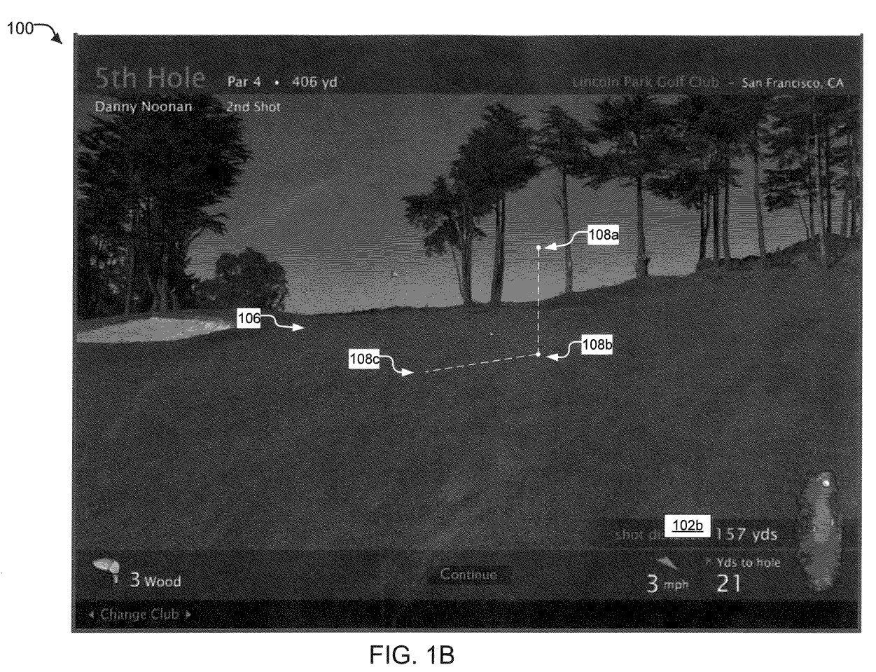

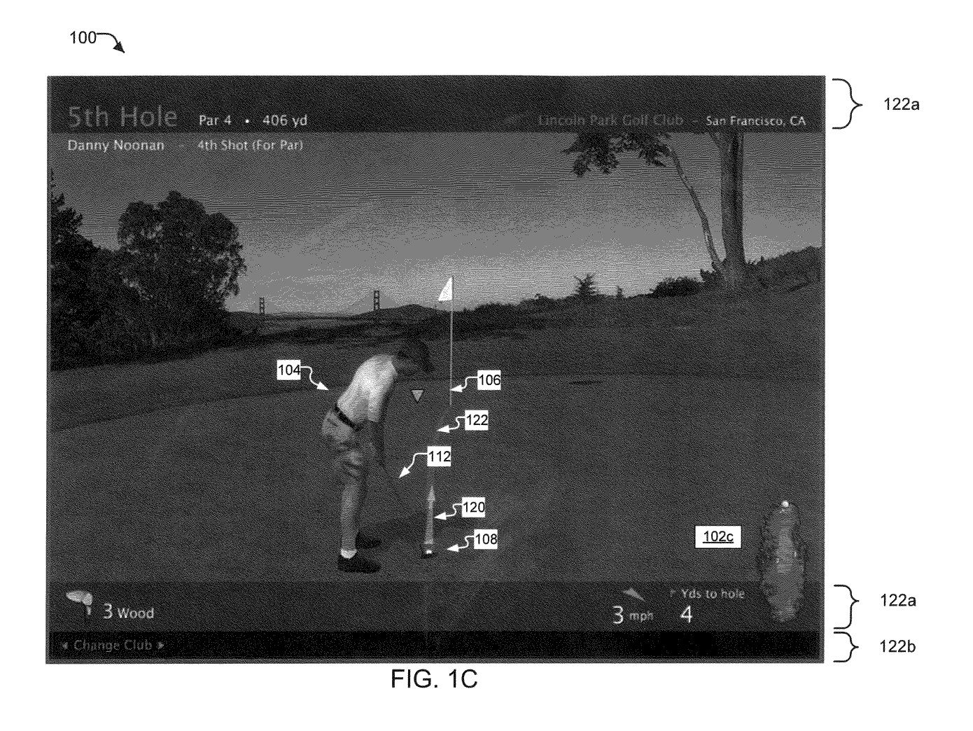

FIG. 1A illustrates an example graphical user interface (GUI) 100 for a computer golf game that incorporates digital representations of photographic images of an actual golf course (e.g., 102a) into the game play. Various visual representations of virtual objects have been integrated into the presentation of the photograph 102a, including an avatar 104 representing the player, a piece of virtual equipment 112 representing a golf club, and a virtual object 108 representing a golf ball. The player provides user input to the electronic game which reacts by altering the state of the game's virtual universe based on the input and interaction of virtual objects in the virtual universe. The game's state at a point in time can be represented by a set of values.

For example, player input can cause the avatar 104 to appear to hit the ball 108 with the club 112 towards the end of the green. A game engine can simulate the physics of the ball 108's aerial trajectory and eventual interaction (e.g., bouncing and rolling) with a physical golf course terrain in a virtual golf course. A course terrain is a 3D model of the topography of the physical course terrain (e.g., a golf course). A course terrain includes elevation data for a course and can be represented as a 3D digital elevation map (e.g., terrain mesh) of features on the course. The course terrain is used to simulate how virtual objects physically interact with the virtual course and where the virtual objects appear in photographs of the course. Topography data can be collected in a number of ways including, but not limited to, aerial photogrammetric mapping (APM), laser 3D imaging and GPS-real-time kinemetric (GPS-RTK) surveys. As will be described below, the new location of the ball 108 in the virtual golf course is mapped to corresponding 2D location in the photograph 102a, or a different photograph, so that the ball appears in the proper place and at the proper scale in the photograph as though the ball was actually in the original photograph. In this way, the player is provided the experience of playing on an actual golf course.

In various implementations, a visual meter 145 is provided to indicate the amount of backswing that corresponds to the player's input manipulating the club 112. In some implementations, the further the club 112 is pulled back, the more difficult it is for the player to accurately contact the ball 108 with the sweet spot of the club 112. The sweet spot is the portion of the clubface that produces optimum distance and ball flight or does not cause the club to torque or twist to either side when contact is made with the ball. More information on factors affecting the sweet spot can be found in U.S. application Ser. No. 11/407,163, filed Apr. 18, 2006, entitled, “Automatically Adapting Virtual Equipment Model”, which is incorporated by reference herein for all purposes. The optimum club contact timing and location can be indicated by a goal bar 152. Various ranges outside of the goal bar 152 indicate how difficult it will be for the player to make a great shot (area 150), a good shot (area 154) or a poor shot (area 156). The great shot area 150 can correspond to hitting the ball 108 with the sweet spot of the club 112 in a live golf game. A maximum possible shot area can be indicated by a bar 148. As the player increases the backswing, the good and great shot areas 154, 150 can shrink, indicating increasing difficulty in controlling the club 112 as the player increases its backswing. In some implementations, the different areas that indicate difficulty are shown in different colors. In some implementations, the different areas that indicate difficulty are shown with outlines that contrast with the background. In yet other implementations, the difficulty areas are not strictly separate areas, but are shown as gradations, where the locations closest to the goal bar 152 are the better shots and locations further form the goal bar 152 are the worse shots.

The player then initiates a downswing motion after the backswing height has been selected. By way of illustration, the player can initiate the downswing motion by either reversing the motion used to cause the golfer avatar 104 to perform its backswing, releasing pressure from a scroll wheel or releasing a button that is held while the user uses the scroll wheel to input the backswing action. The club head location indicator 146 then moves along the meter 145, approaching the goal bar 152. The player selects the quality of the golf swing by selecting either a button or a scroll wheel when the club head location indicator 146 is close to the goal bar 152, for example. How close the player is able to get the club head location indicator 146 to the goal bar 152 when the player makes the selection determines how the club 112 will impact the ball 108. In some implementations, the closer the player is able to get the club head location indicator 146 to the goal bar 152, the straighter the shot and/or the further the ball flies in response. If the player does not provide the input device with input quickly enough and misses the goal bar 152, the club head indicator 146 continues to progressively move farther out into the great area 150, the good area 154 and finally the poor area 156. In some implementations, if the player activates the impact with the ball too soon or too late, the golfer hits the ground with the club, slices or hooks the ball.

In various implementations, the player can also select a greater backswing, as indicated by the height of the golfer's club 112. A greater backswing may be used to drive the ball down the fairway. The great area 150 is smaller when the golfer avatar 104 increases its swing as compared to when the player is putting, chipping or pitching the ball, for example. That is, there can be an inverse relationship between the size of the sweet spot and the power of the swing. The downswing and impact are similar to other swings, but with increased difficulty in accurately making impact with the ball. This is described further in U.S. application Ser. No. 11/619,919, entitled “Rotational Game Input”, filed on Jan. 4, 2007, the entire contents of which are hereby incorporated by reference.

In some implementations, the manner in which the player uses the input device, such as a scroll wheel, a keyboard or a mouse, affects an aspect of the golfer's swing. For example, when the input device is a scroll wheel device the speed of the player's arcuate input into the scroll wheel device as the player initiates the down swing can affect the golfer's swing, such as by determining in part the speed of the golfer's swing or the distance of the shot. Alternatively, or in addition, the smoothness of the player's tempo of the motion on the scroll wheel can determine how straight the shot is. Hesitation or jerkiness of the player's action can cause the shot to either slice or hook. In some implementations, the player can input that he or she is a right handed player or a left handed player. The type of action that depends on the direction of rotation on the scroll wheel, that is, a clockwise or a counter clockwise direction indicating the backswing, can change depending on the handedness of the player.

Various methods of initiating the downswing and impact time can be used in place of or in conjunction with methods described above. In some implementations, after causing the golfer to backswing, the player releases the scroll wheel to start the downswing. In other implementations, the player selects a button or taps the scroll wheel to initiate the downswing.

In addition to a scroll wheel device, the user input device may be a mouse, a joystick or buttons. Other user input devices are possible. The movement of the mouse, the length of time the joystick is held in one direction or the length of time that a button is depressed may effect the golfer's swing or the distance of the shot. Additionally, some combination of depressing buttons or moving a mouse may determine the amount of backswing, the moment of impact with the ball, the amount of follow through, or the direction of the ball.

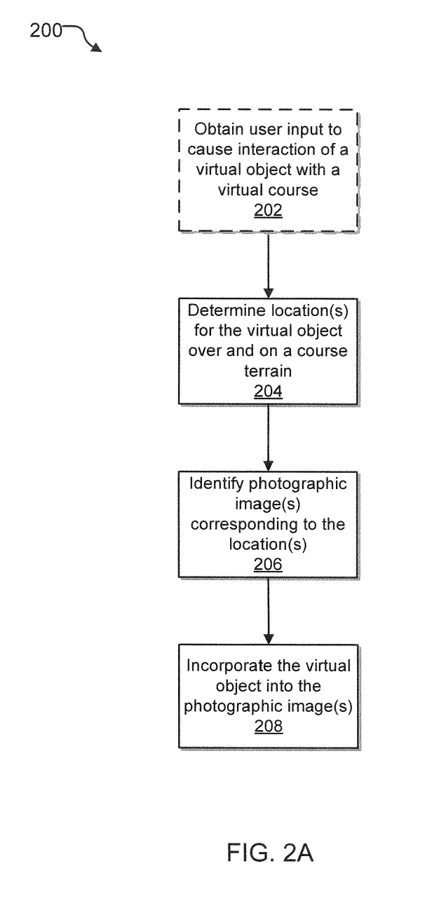

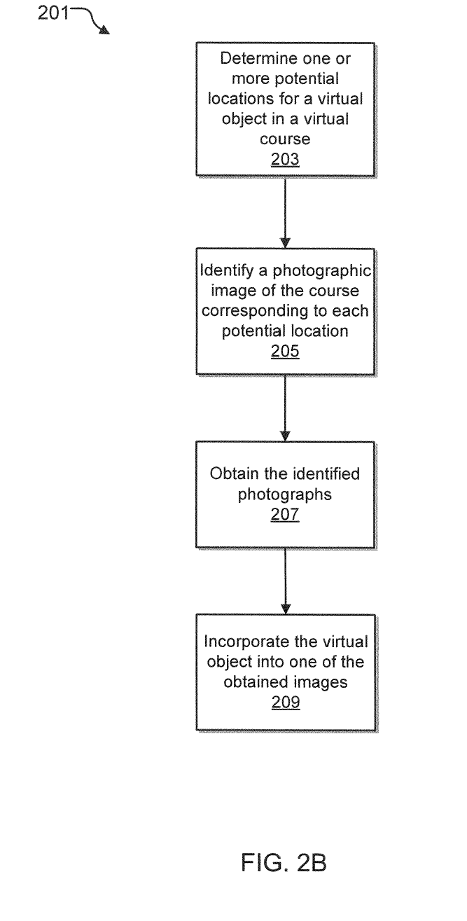

FIG. 2A is a flowchart 200 of an example technique for photographic mapping in a stimulation such as an electronic game. User input is optionally obtained which causes one or more virtual objects (e.g., golf ball 108) to interact in a virtual course (step 202). Based on a simulation or other means, one or more new locations for a virtual object on or above the course terrain are determined (step 204). For example, a game engine can simulate the physics of a virtual golf ball's trajectory, collision with a virtual tree, and the ball's eventual landing, rolling and resting on the course terrain. In various implementations, the movement of the ball from the time from when the ball is put into play until when the ball comes to rest is represented by a 3D path through the virtual course. When the ball is airborne, the path is above the course terrain and when the ball is in contact with the course terrain, the path lies on the terrain. The path is considered part of the state of the golf game's virtual universe. Positions along the path can be identified for purposes of determining the location of the ball in the virtual course over time.

One or more photographic images of the course corresponding to the virtual object's new location(s) on or above the course terrain are identified (step 206). If there is more than one virtual object, a photograph corresponding to an area of the course encompassing the location of all of the virtual objects can be identified. In various implementations, where there are multiple photographs covering a given course location, the photograph that provides the best view from the player's perspective is chosen. For example, a photograph which is closest to centering on the location of the virtual object's new location would be chosen. Alternatively, more than one photograph of the virtual object's new location can be digitally stitched together to form a single, composite photograph. Other techniques for photograph selection are discussed below. The virtual object is then incorporated into the photographic image(s) using a mapping technique that is described below (step 208). The virtual object can be animated in the photograph(s) and appears at the proper location and scale based on the virtual object's location in relation to the course terrain.

FIG. 2B is a flowchart 201 of an example technique for pre-fetching photographic images for mapping in a simulation such as an electronic game. Pre-fetching photographic images can improve the responsiveness of interactive applications by locally caching photographs ahead of time before they are needed. This is especially true if images need to be retrieved from remote storage such as a server. One or more potential locations for a virtual object in a virtual course are determined (step 203). In various implementations, the determination can be derived where game play, for example, is expected to proceed based on a user's playing history or on the playing history of a group of users for that particular part of the virtual course. By way of illustration, playing history can include information identifying past locations of virtual objects in the virtual course for the user and measures of the user's playing abilities. Player history can include other information. A photographic image of the course corresponding to each potential location is then identified (step 205). The identified photographs are then pre-fetched (e.g., cached) so as to be ready for possible incorporation into the game play (step 207). The virtual object is then incorporated into one of the obtained images (step 209) based on the new location of the virtual object. In some implementations, the game can obtain all photographs of the terrain corresponding to the next hole of golf.

Some or all of a virtual object's movement in the virtual course can be animated in a course photograph. For example, after the player strikes the golf ball 108 in photograph 102a (as shown in FIG. 1A), photograph 102b (as shown in FIG. 1B) can be presented to the player along with animation of the ball 108 falling from the sky at location 108a, impacting the golf course at location 108b, and rolling to resting location 108c. If the ball 108 were to continue rolling beyond the edge of the photograph 102b, a new photograph corresponding to the ball 108's new location could be displayed. This can continue until the ball 108 comes to rest. Alternatively, only the last such photograph (i.e., the photograph of the virtual object's resting place) need be presented. Visual representations of other virtual objects can also be animated in the photograph 102a. For example, the avatar 104 can be animated such that the avatar 104 swings the golf club 112 and reacts to the swing. As another example, a golf flag 106 can be animated such that the golf flag 106 moves in the wind.

Additional graphical information to help the player can be incorporated into the photograph and the GUI 100. As shown in FIG. 1C, a directional aiming arrow 120 is provided to assist the player in setting up a shot. An animated arc 122 can be drawn on the photograph to show the player the path the golf ball 108 will take in the air and on the course. Alternately, the arc 122 can be drawn as the golf ball 108 moves in the photograph 102c. Two status areas 122a-b are incorporated into the GUI 100 to provide information such as the current location in the virtual course, the player score, distance to the hole, wind speed and direction, and the virtual club the player is using.

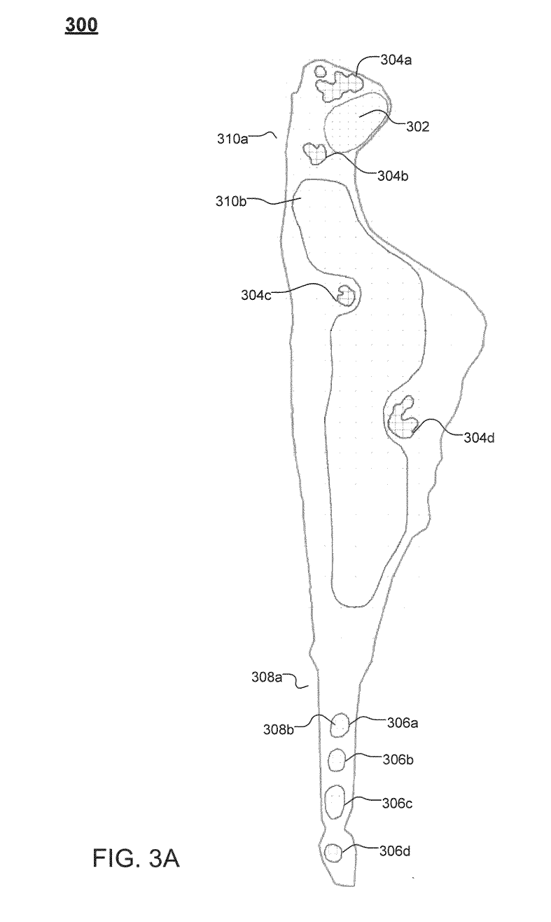

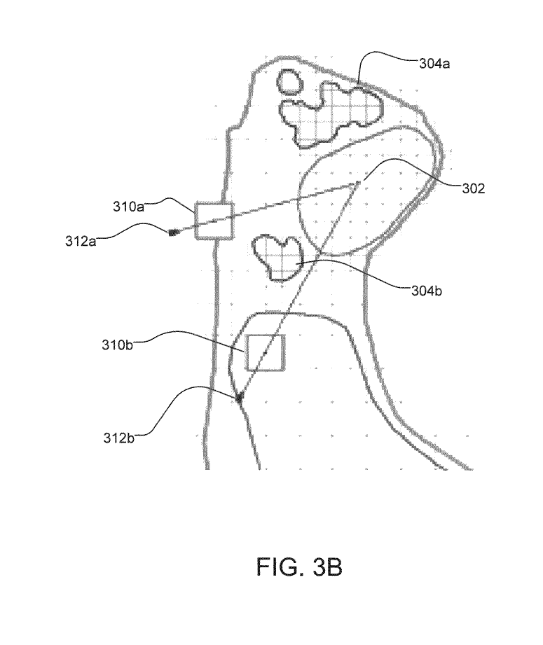

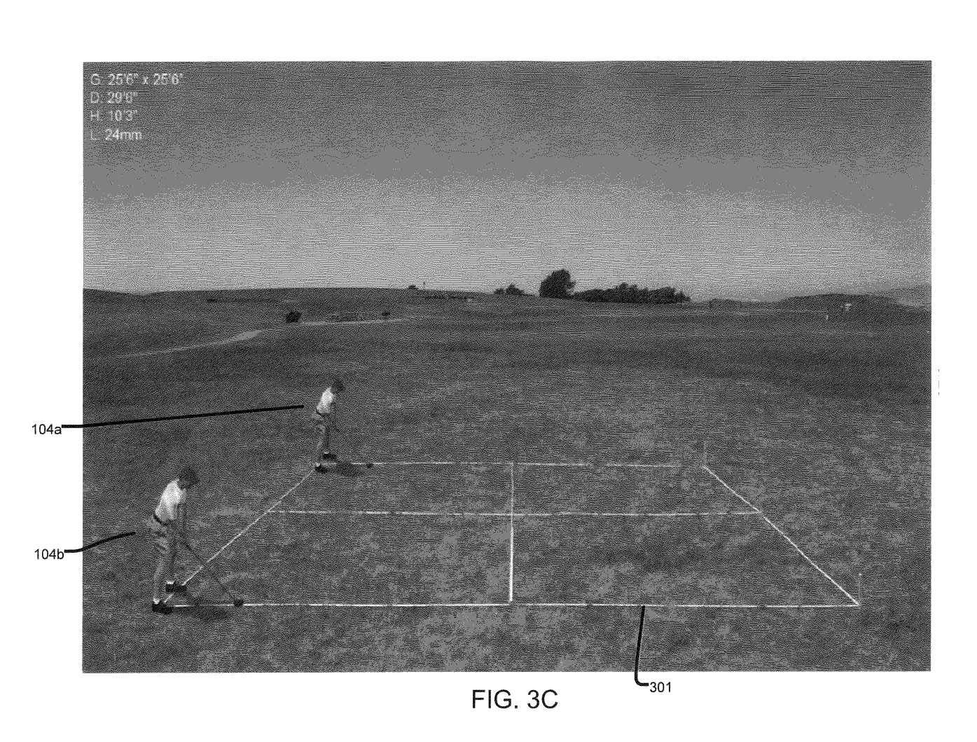

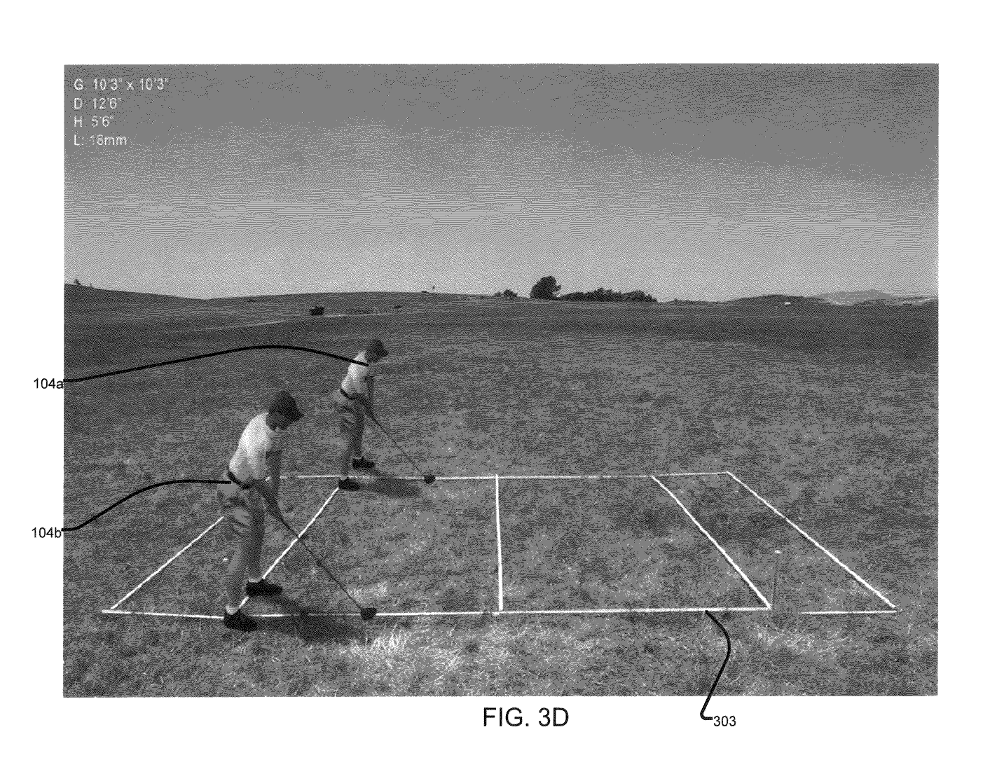

In order to systematically photograph an actual course (e.g., a track, a golf course, a baseball diamond, a football field, a tennis court, one or more roadways) for use in electronic game or other application, the course can be manually or automatically divided into a grid of cells. Each cell defines a physical area of the course that will be photographed for use in the simulation. Each cell can have one or more photographs associated with the cell. In various implementations, a cell photograph captures the area of the course corresponding to the area of the cell. FIG. 3A illustrates an example course grid 300. A course can be of any size and shape, and can include non adjacent areas. Likewise, cells can have different sizes, shapes and do not have to be adjacent to one another. Depending on the portion of the course they cover, cell density can change. In various implementations, cell density increases in course areas where players are more likely to interact with virtual objects.

In the world of golf, for example, these areas would be putting greens (e.g., 302), tee boxes (e.g., 306a-d) and hazards such as sand traps (e.g., 304a-d) and obstructions such as trees that golfers must circumnavigate. In other areas of the course, cell density is decreased meaning fewer course photographs need to be taken. In various implementations, lower density cell areas have a lower frequency of balls landing in them, require a wider area of visibility for the player, or both. In various implementations, automatic image recognition techniques can be used to identify such areas of a course based on recognizing certain visible features (e.g., putting greens, sand traps, trees). By identifying areas of a course as having a high or low probability of player interaction, a course can be automatically divided regions having appropriate cell densities.

In various implementations, a course can have more than one layer of cells. The need for this may arise, for instance, to handle situations when a player, due to accident or poor skills, causes a virtual object to be located in a part of the course that rarely sees play. In FIG. 3A, small cell 308b for tee box 306a is the cell used by default for a photograph at this stage of the course since most players are able to hit the ball quite a distance up the fairway. However, some players may cause the ball to land in close proximity to the tee box 306a. The area just outside of the tee box 306a is not included in the photograph for cell 308b. However, secondary cell 308a overlaying the default cell 308b can be used to obtain a photograph when the ball lies within the bounds of cell 308a. The photograph for the secondary cell 308a encompasses the tee box 306a and the surrounding area. A layer can be chosen based on rules or heuristics that can depend on the state of the virtual universe at a particular point in time. In various implementations, a layer is chosen based on which provides the smallest cell size for the location of a virtual object. In other implementations, a layer can be chosen based on a required style of presentation. For example, it may be desirable to show a ball in flight passing through a cell for dramatic effect.

As discussed above, in various implementations each cell in a course grid is photographed such that the photograph encompasses the area of the course in the cell. For example, the photograph shown in FIG. 3C is of a 25′6″×25′6″ cell indicated by the boundary 301. Two avatars (104a-b) have been rendered in the photograph to illustrate how the scale of virtual objects change based on their position on a course terrain. This is described in more detail below. The photograph is taken by a camera at a specified 3D position (longitude, latitude, and altitude) in the actual course. A camera's 3D position can be determined by use of a Global Positioning System (GPS), radio triangulation, or a ground based navigation system, for example. Since the position of each cell is known, the camera position can be specified as a setback distance from the cell and a height above the cell. In the photograph of FIG. 3C, the camera is positioned 29′6″ away from the cell and a height of 10′3″ above the cell. A 24 mm lens was used for the photograph. FIG. 3D is a photograph of a 10′3″×10′3″ cell where the camera was positioned at a setback of 12′6″ and a height of 5′6″, and using a 18 mm lens.

FIG. 3B illustrates an example of how photograph parameters can be derived from a cell in a course grid 300. In various implementations, a camera's position and direction can be determined based on a target position for a given cell. In golf, for example, generally the target will be the hole unless the fairway turns such that players must aim for the turn in order to set up a shot for the hole. In this later case, the target would be the turning point in the fairway. The target for cells 310a and 310b is hole 302. A line passes through the center of each cell to the target. It is along this line that the camera lens will point towards the target. The location of the camera on the course will be along the line and outside of the cell. Cell 310a's camera is located at position 312a along the line defined by endpoints 312a and 302. Likewise, cell 310b's camera is located at position 312b along the line defined by endpoints 312b and 302.

In various implementations, the focal length of the lens, the angle of the lens, the offset of the camera from the edge of the cell, and the height of the camera can be predefined for a given cell size. In another implementation, one or more of the focal length, the angle of the lens, and the 3D location of the camera can be dynamically determined. By way of illustration, such a determination can take into account the physical terrain that corresponds to the cell. If a given cell was in a valley, for instance, it could be beneficial to provide more of an overhead shot so that a player does not lose perspective with the surrounding course area.

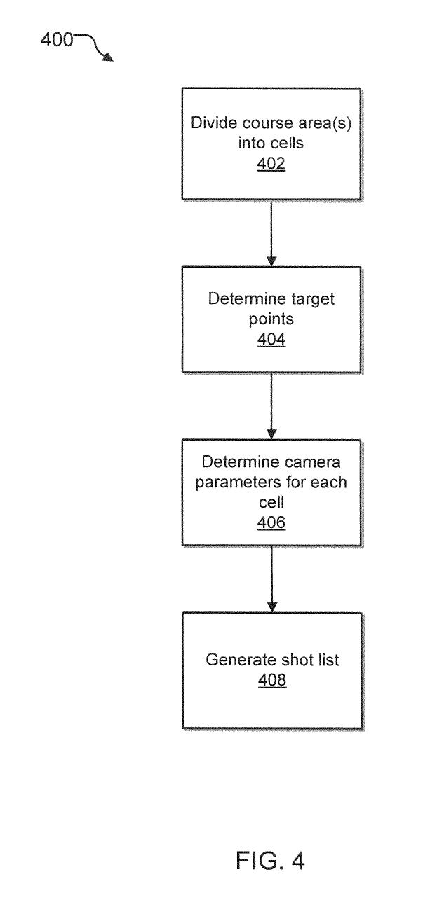

FIG. 4 is a flowchart illustrating an example technique 400 for automatically dividing a course into cells and generating a shot list. Since a course can be automatically divided into cells and since camera parameters for each cell can be automatically determined, a so-called shot list can be automatically determined. A shot list is a list of photographs that need to be taken for cells in a given course. Each shot includes a 3D location of the camera, lens focal length, direction, and angle. A course is initially divided into cells as described above (step 402). One or more target points are determined for the course (e.g., 302; step 404). Camera parameters are determined for each cell based on the target point(s) and/or cell size (step 406). Finally, a shot list is generated describing the camera requirements required to photograph each cell on the course (step 408). In a further implementation, the shot list can be downloaded to a robotic device with an attached camera such as a robotic helicopter capable of hovering at precise 3D coordinates. The robotic device can then carry out capturing photographs for one or more of the cells.

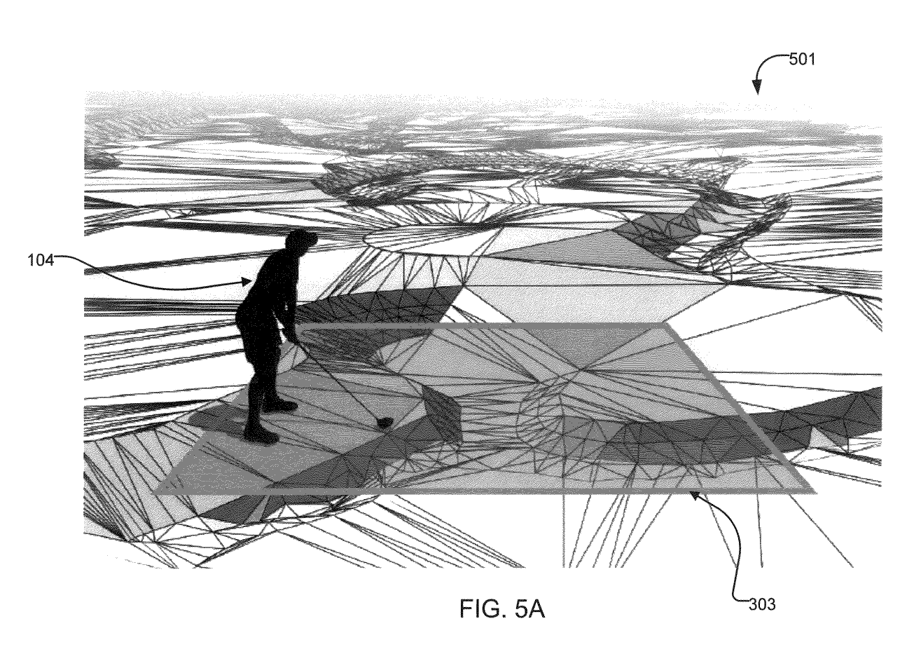

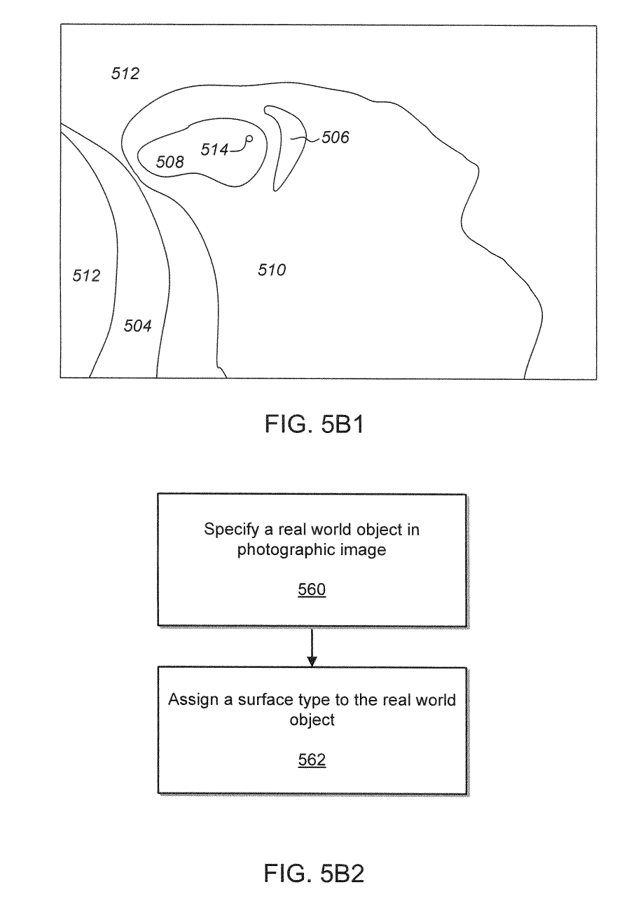

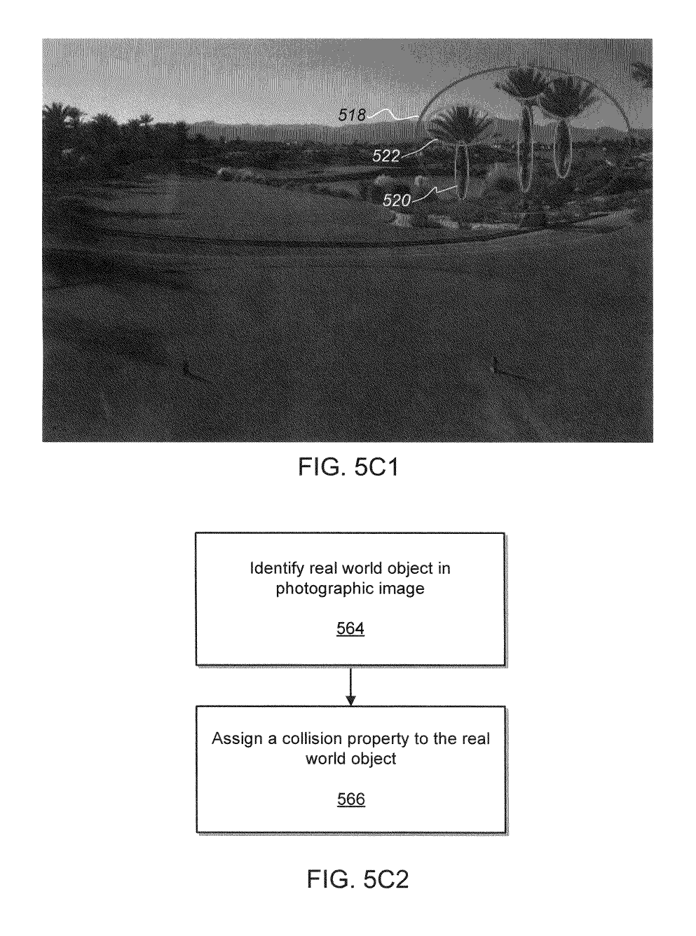

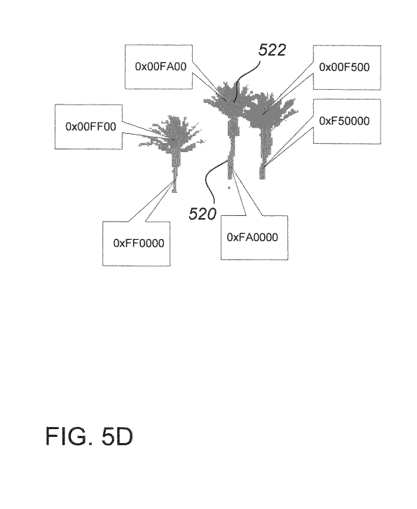

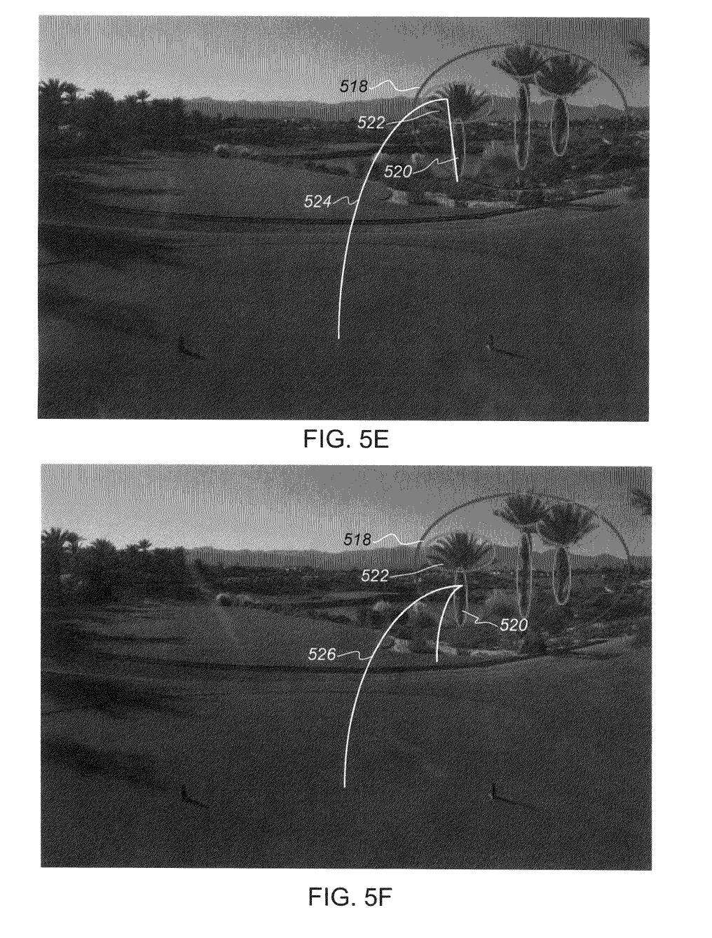

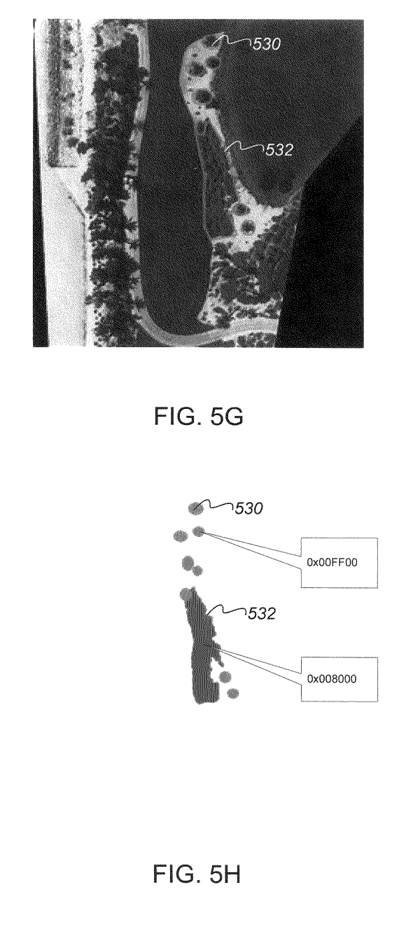

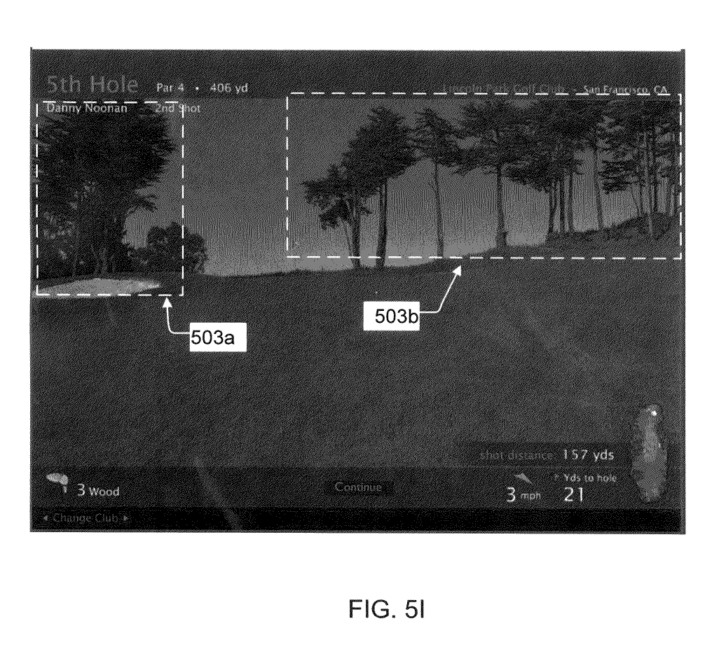

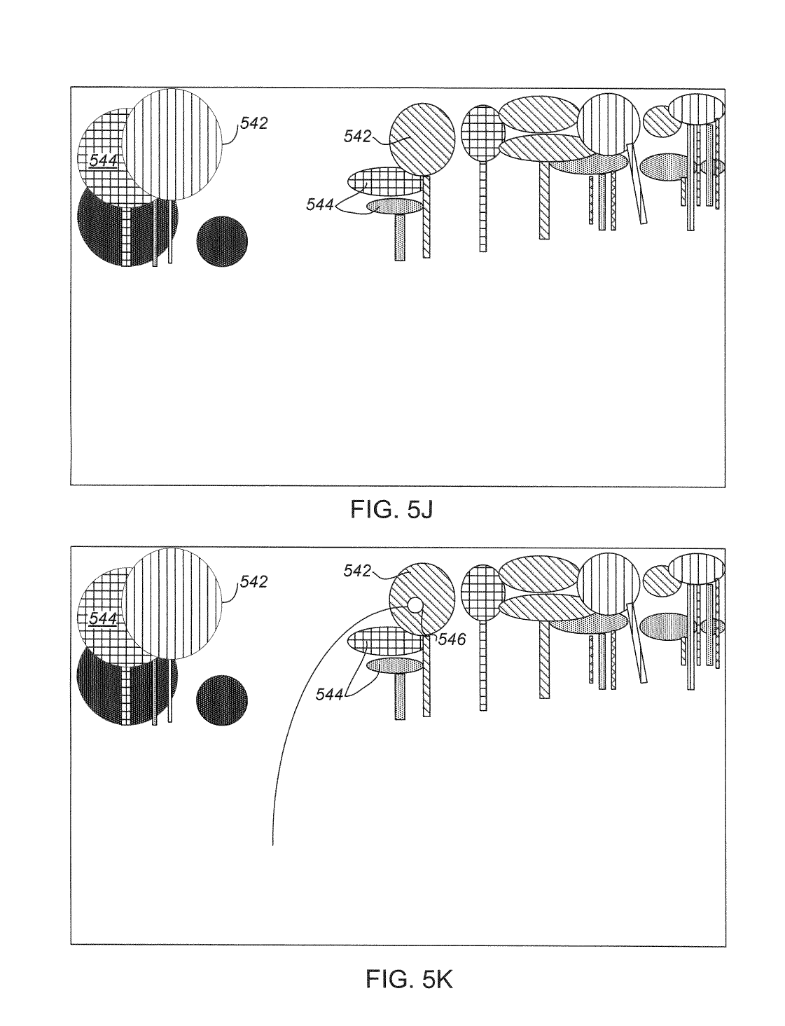

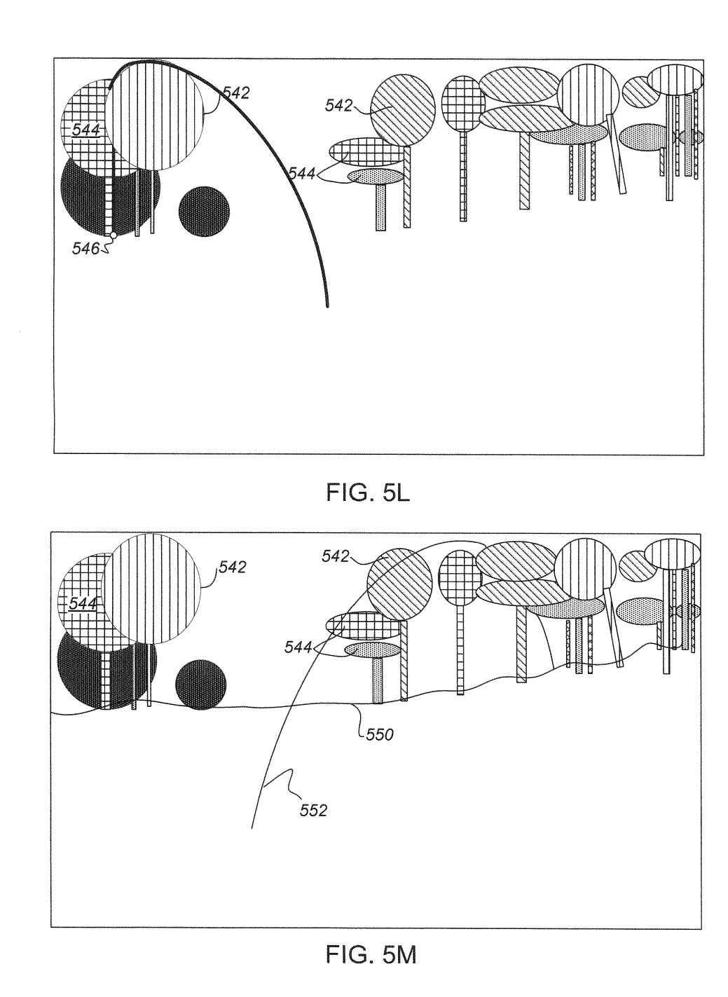

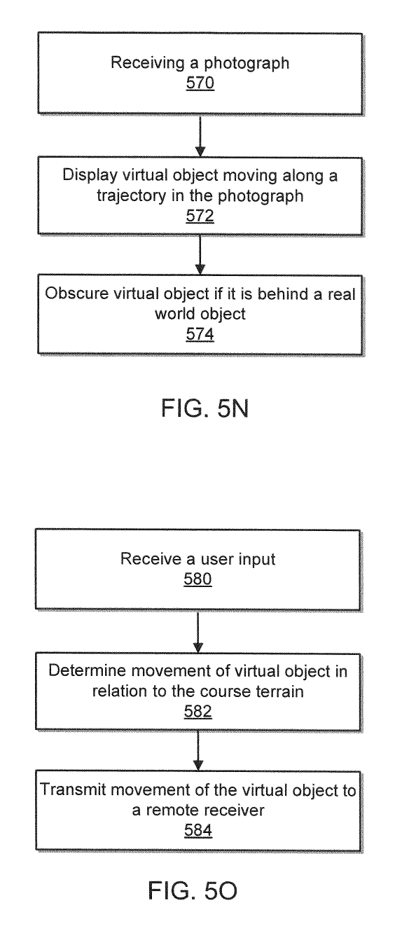

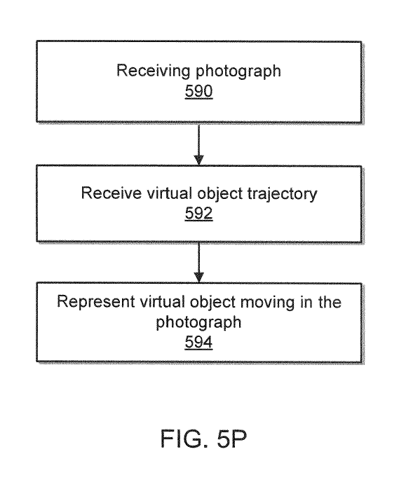

FIG. 5A is an illustration of an example of a course terrain 501 for a virtual course. Each cell (e.g., 303) maps to a portion of the course terrain 501. In addition to the topography information that the course terrain 501 provides, surface type information can be integrated into the course terrain 501 to further increase the realism of virtual objects' interaction with the course terrain 501 and objects on the course terrain 501. By way of illustration, a ball that lands in the rough tends to lose momentum more quickly than a ball that lands on the green. A ball that hits the cart path, which is a hard surface, such as concrete, tends to bounce more and roll faster than a ball that hits grass. Even the direction of lie of the grass on the green can affect friction that acts on the ball and therefore changes the speed of the ball. Wet grass can decrease the coefficient of friction and cause the ball to slide more than dry grass, but can also increase the springiness of the grass and increase the roll resistance of the grass. A ball that lands in a sand trap loses momentum and tends to roll or slide little. A ball that lands in a water hazard sinks and its post-land movement is irrelevant to the player.

Once a ball is hit with a face of a club, the ball has a velocity, direction, spin rate and spin direction. These are described further herein. Hitting the ball either puts the ball into flight or pushes the ball along the ground. The velocity of the ball can range from a maximum of about 75 m/s, which is a drive by a professional golfer, to about 26 m/s at the end of a drive. A put is generally around 1.83 m/s and any balls rolling faster than 1.63 m/s will not be captured by the cup.

A rolling model of the ball simulates the behavior of the ball as it rolls across a surface. Rolling begins when the ball approaches the surface from flight, such as within several millimeters of the surface, and the normal component of the ball's velocity is below a particular threshold. When the ball is rolling, the ball is subject to gravity, wind, friction and a normal force from the surface. The ball continues to roll until reaching an equilibrium state, where the velocity and the gravity, wind, friction and normal forces are approximately zero.

As a golf ball rolls, rolling friction slows down the angular velocity of the ball. A rolling friction of a golf ball can be between about 0.054 and 0.196 on a green (based on Stimpmeter ratings). Grass on the fairways is at the high end of this range, and the rough and sand traps are even higher. If the grass is wet, the friction can be greater than the same type of dry grass.

The coefficient of friction describes how much resistive force is generated by sliding a ball along a surface. A golf ball sliding on a green can have a value of between about 0.25 and 0.50, such as about 0.4.

In the course of simulating the golf ball's trajectory, the friction force that results from sliding across a surface can be determined. Sliding friction is a contact force that arises when two surfaces in contact with one another have a non-zero relative velocity. The direction of the friction force is opposite the direction of relative motion, while the magnitude of the force is based on physical properties of the two surfaces involved. The Coulomb model provides a reasonable estimate of the maximum magnitude of the friction force, based on the magnitude of the normal force and an experimentally determined coefficient.

Calculating the actual direction and magnitude of the friction force can be more complicated, especially when rotational movement is considered. Angular velocity, or spin, can increase or decrease the relative contact velocity. A rolling object, for example, has a contact velocity of zero, and thus experiences no sliding friction. A rolling object does, however, experience a separate force, called rolling friction, which acts to oppose the object's motion. Rolling friction typically arises from energy losses caused by deformation of one or both of the objects involved. Furthermore, sliding friction usually generates a torque that works towards establishing rolling, in effect canceling itself out.

An algorithm for computing the average friction force over a fixed duration for a sphere on a flat surface can account for linear and angular velocity, as well as external linear accelerations, such as gravity. Physical properties of the sphere, like radius, mass and moment of inertia are also incorporated into the result.

The algorithm could be considered an extension of the Coulomb model. The algorithm begins by determining how much friction force it takes to start—or maintain—rolling over the given duration. It then limits this quantity by the maximum amount estimated by the Coulomb model.

Rolling can be defined as follows. Let v_{cm} be the velocity of the center of mass, ω be the angular velocity, and r be the vector from the center of mass to the contact point. The velocity of the contact point can be determined by v_{cp}=v_{cm}+(ω×r). If the sphere is rolling, the velocity of the contact point is zero, which implies

$$\vert ω \vert = - \frac{\vert {ν}_{cm} \vert}{\vert r \vert} .$$

Next, the force required to start the ball rolling over a particular interval is determined. If v_{cm}, v_{cp} and ω are functions of time (indicated by a subscript), and the time interval is defined as ranging from 0 to t, the following equations can be used:

v_{cp,0}=v_{cm,0}+(ω₀×r)

v_{cp,t}=v_{cm,t}+(ωₜ×r)=\hat{0}

Let x be the total external tangential force. An example of this would be the component of gravitational force parallel to a sloped surface. This represents any external force that affects the relative contact velocity but does not apply a torque to the sphere.

Let m be the mass of the sphere, and I be the moment of inertia. If F_{R} is the amount of force that must be applied over time t to ensure the ball is rolling, the following equations can be used to determine the velocities:

$$\begin{matrix}{v}_{cm , t} = {v}_{cm , 0} + ( \frac{{F}_{R} + x}{m} ) t \\ {ω}_{t} = {ω}_{0} + \frac{( r + {F}_{R} )}{I} t\end{matrix}$$

This implies:

$${F}_{R} = ( \frac{{v}_{cm , 0} + ( {ω}_{0} \times r ) + \frac{x}{m} t}{( \frac{1}{m} + \frac{{r}^{2}}{I} ) t} ) = - ( \frac{{v}_{cp , 0} + \frac{x}{m} t}{( \frac{1}{m} + \frac{{r}^{2}}{I} ) t} )$$

The algorithm then proceeds to calculate the maximum friction based on the Coulomb model, using the normal force F_{N} and an externally defined coefficient of friction μ. The direction of the friction force is given by

$$\frac{{F}_{R}}{\vert {F}_{R} \vert}$$

and the magnitude is given by min(μF_{N},|F_{R}|).

This algorithm can also be used to calculate the frictional impulse J_{T} that occurs during a collision. Similar math yields the following formula:

$${J}_{T} = - ( \frac{{v}_{cm , 0} + ( {ω}_{0} \times r )}{( \frac{1}{m} + \frac{{r}^{2}}{I} )} ) = - ( \frac{{v}_{cp , 0}}{( \frac{1}{m} + \frac{{r}^{2}}{I} )} )$$

When a ball lands from flight, often the ball bounces, in part due to the elasticity of the ball and the hardness or elasticity of the surface. A scalar value that describes the amount of energy lost when the ball bounces on a surface is the coefficient of restitution. Soft surfaces, such as sand, have lower coefficients of restitution than firmer surfaces, such as greens and cart paths. Soft turf can have the following values for the coefficient of restitution

e=0.510−0.375v+0.000903v² for v≦20 ms⁻¹

e=0.120 for v>20 ms⁻¹

where v is the impact speed normal to the surface. See, e.g., Penner, A. R. “The physics of golf: The optimum loft of a driver,” American Journal of Physics 69 (2001): 563-568.

An impact parameter is a scalar quantity measured in radians to describe the amount of surface deformation cause by a ball impact. In some implementations, the calculations use a Cartesian coordinate system where the x axis represents the east/west position and the y axis describes the north/south position and the z axis is a height, or up/down position. Thus, vₓ is the velocity of the ball in the east/west direction and v_{y} is the velocity of the ball in the north/south direction. A rough approximation for the impact parameter can be estimated from the following equation.

$${θ}_{c} = 0.269 ( \frac{v}{18.6} ) ( \frac{φ}{0.775} ) where φ = {tan}^{- 1} \vert \frac{{v}_{x}}{{v}_{y}} \vert$$

See, e.g., Penner, A. R. “The run of a golf ball,” Canadian Journal of Physics 80 (2002): 931-940. Softer surfaces, such as sand, have a higher impact parameter than harder surfaces, e.g., cart paths, which experience relatively little deformation and are almost independent of impact speed or impact angle.

The virtual ball's flight, rolling, bounce and slide actions can be approximated to estimate the real motion of a ball. The flight can be estimated using the following model, which incorporates the effects of gravity, lift and drag on the ball. Ball flight begins after the ball is struck, such as by a club face, and continues until the ball collides with the ground or an obstacle, such as a tree, golf cart or other object in the landscape. After a collision, the ball can continue in flight if the ball still has upward displacement or velocity. If the ball does not have any upward displacement or velocity, a rolling model is used to determine the ball's movement, instead of the night model.

To determine the ball's flight, the drag force on the ball is calculated. The coefficient of drag, CD, can be determined from equations generated by fitting curves to data collected from live balls (see, e.g., Bearman, P. and Harvey, J. “Golf Ball Aerodynamics,” Aeronautical Quarterly 27 (1976): 112-122.). The velocity is derived from the velocity of the ball after the ball is hit. Rho is the atmosphere density, in kg/m³. The radius r of a golf ball is at least 4.27×10⁻² meters.

$${F}_{D} = \frac{1}{2} ρ ( π {r}^{2} ) {C}_{D} {v}^{2}$$

The lift force on the ball is calculated using the following equation. The coefficient of lift, C_{L}, can be determined from can be determined from equations generated by fitting curves to data collected from live balls (see, e.g., Bearman, supra).

$${F}_{L} = \frac{1}{2} ρ ( π {r}^{2} ) {C}_{L} {v}^{2}$$

Optionally, atmospheric conditions, such as wind and air density, are used to modify the ball's flight path. If atmospheric conditions are accounted for, the wind velocity is determined. The wind can be represented as a function of time and position, which returns a vector quantity indicating the direction and speed of the wind. At least three different wind models can be used. A basic wind model varies the wind direction and speed over time, but assumes that the wind is the same everywhere on the course. Because wind speed usually decreases close to the surface of the ground, the wind model can be scaled linearly to 0, which may require using the 3D terrain data for the course. Further, because wind can be shaped by local geographic features, such as hills or valleys, the wind speed and direction can be altered based on the local geographic features. For example, a hill can create a wind shadow. A wind vector can be stored for each point on a hole. A vector field can be implemented by placing an image map over the course terrain for the hole and using the three channels of the image map to represent the components of the wind vector along each axis. The vectors can represent absolute wind vectors or a relative offset from a global wind vector. Each vector field can be tied to a prevailing wind direction. The ball's fluid velocity can be calculated by subtracting the ball velocity and adding the wind velocity. Headwinds increase and tailwinds decrease the apparent fluid velocity.

The direction of the lift force is determined by the vector product of the fluid velocity and the ball's axis of rotation.

The ball's gravitational force is calculated, using mass times the gravitational acceleration constant of 9.8 m/s². A golf ball's maximum mass is 45.93 grams, according to USGA rules. The ball's mass is also used to calculate the ball's linear acceleration, where the sum of forces is divided by the ball's mass.

In addition to lift and drag, the spinning golf ball is subject to friction with the surrounding atmosphere. This friction applies a torque, which decreases the ball's rate of spin. The flight model uses a coefficient of moment (Cₘ) to calculate the magnitude of the frictional torque (τ) using the following equation:

$$τ = - ρ ( π {r}^{2} ) {C}_{m} {v}^{2} ( \frac{ω}{\vert ω \vert} ) ( 2 r )$$

The coefficient of moment is calculated as a linear function of the spin ratio, which is defined as the ratio of peripheral speed to the fluid speed. This function has a typical constant around 0.009.

The resulting spin deceleration is given by:

$$α = \frac{τ}{I}$$

where I is the moment of inertia.

The position of the ball over time, or the trajectory, is determined based on a position, velocity and acceleration of the ball. The movement of the ball can be calculated for each time step, where the time step is between about 0.001 and 0.01 seconds. However, other time steps can be used as required to minimize artifacts and so long as the time steps are not so small as to make the computations overly expensive.

If the ball is no longer in flight and begins rolling, the characteristics of the surface are used to determine the friction force on the ball. If the ball is transitioning from flight to rolling and there is a bounce during the transition, a bounce model is used to simulate the interaction of the ball with the surface on which the ball bounces. The bounce model uses the properties of both linear and angular momentum and friction to determine new values for linear and angular velocity of the ball and is described below.

The bounce model simulates the interaction of the golf ball with the surface of the course. It uses the properties of conservation of momentum (linear and angular) and friction to determine new values for the linear and angular velocity of the ball.

The bounce model, and particularly the concept of an impact parameter, is based on the model described in Penner, A. R. “The run of a golf ball,”. Canadian Journal of Physics 80 (2002) 931:940. The model is extended to three dimensions and modified to support an optional shear parameter for the surface.

The bounce model is parameterized by the surface description and surface normal at the point of contact, as well as the physical properties of the ball.

The bounce model begins by calculating the amount of surface deformation caused by the ball's impact. The degree of deformation is estimated by an angular impact parameter, which is based on the impact speed and angle of the ball. The bounce model uses the impact parameter to determine the impact normal Nᵢ, which is the effective surface normal after deformation. The impact normal is calculated by rotating the surface normal towards the inverse of the impact velocity direction. To match physical intuition and to prevent artifacts, the impact normal should not rotate beyond the inverse of the impact velocity direction.

In some embodiments, the impact parameter uses a simple linear approximation based on the impact speed, but more complicated equations could be used to represent different surface types. In particular, a quadratic equation of impact speed may represent surface deformation more accurately, since the amount of surface deformation is likely proportional to the kinetic energy of the ball. However, the simple linear approximation can be sufficient to represent a realistic action taken by the ball.

Using the impact normal, the bounce model calculates the normal and tangential components of the impact velocity. The normal component of impact velocity is used as a parameter in the calculation of the coefficient of restitution for the surface (e). The coefficient of restitution is used to calculate the normal impulse: J_{N}=(1+e)mv_{i,n}. The contact point is also computed (r=−r_{b}Nᵢ), where r_{b} is the radius of the ball.

The bounce model provides two separate mechanisms for calculating the tangent impulse. If the surface defines a shear parameter s the tangent impulse is calculated as J_{T}=−smvₜ. The shear parameter is used to simulate soft, deformable surfaces like sand and water. Otherwise, the tangent impulse is calculated using the algorithm described above with sliding friction.

The rebound velocity (vᵣ) is calculated using the equation mvᵣ=mvᵢ+J_{N}+J_{T}. The rebound spin (ωᵣ) is calculated using the equation

$$I {ω}_{r} = I {ω}_{i} + ( r \times \frac{{J}_{T}}{m} ) .$$

Upon exiting from the bounce model, the simulation can enter either the rolling or flying state. The next state is chosen based on the predicted maximum height of the next bounce, which is given by the following formula:

$$h = \frac{1}{2} \frac{{( {v}_{r} \cdot n )}^{2}}{g}$$

where h is the predicted height, vᵣ is the rebound velocity, n is the surface normal, and g is the gravitational acceleration constant. If the predicted bounce height is above a threshold value, the ball continues flying. Otherwise, the ball begins rolling.

The rolling model described herein can be calculated by calculating the rolling normal. This is a combination of the surface normal at the point beneath the ball and a sampled normal using the terrain elevations around the ball. The sampled normal is calculated by determining two sample points based on the horizontal velocity of the ball. The elevations of these two points, along with the elevation of the point beneath ball, define a plane. The slope of this plane provides an estimate of the normal for the larger region and implements a rough low pass filter on the terrain normal. By using the horizontal speed of the ball to scale the distance of the sample points, the frequency of the low pass filter can be increased as the ball slows down, implementing a basic adaptive filter.

The rolling model next checks whether the ball is below the surface of the terrain. If so, it assumes a previous roll calculation underestimated by the slope. The ball is moved above the terrain, any component in the direction of the rolling normal is canceled, and the kinetic energy is decreased by the amount of potential energy gained.

The next step of the rolling model is to calculate the forces and torques acting on the ball. The total force can be divided into the following components: gravity, rolling friction, and sliding friction. Gravitational force is directed downward with a magnitude of mg. Rolling friction is directed opposite the sum of ball velocity and the tangential gravitational force, with magnitude equal to μᵣFₙ, where μᵣ is the coefficient of rolling friction for the surface and Fₙ is the normal force.

Sliding friction force is calculated as described above, with tangential gravitational force and rolling friction as the external forces. The total torque is determined by taking the cross product of the contact vector and the sliding friction force. Total friction and total torque are passed to the integrator, which calculates the position, velocity and spin at the next time step.

In various implementations, golf ball rolling behavior across a sloped surface can be modeled using existing techniques (see, e.g., Penner, A. R. “The run of a golf ball,” Canadian Journal of Physics 80 (2002): 931-940).

In addition to the bounce model and roll model, the ball movement during flight and after coming into contact with the cup and pin can be determined.

The flight model simulates the effects of gravity, lift and drag on the ball. The flight model begins after the ball is struck by the club and continues until the ball collides with the ground or another obstacle. After a collision, the flight model continues if the ball has a significant upward displacement or velocity; otherwise, it transitions to the rolling model. Note: it may also be necessary to transition back into the flight model from the rolling model. This could happen if the ball rolled off a drop-off, or rolled up a ramp with sufficiently high velocity.

The cup model can be used to determine how the ball reacts when the ball reaches the hole. The cup model assumes that the cup is vertically aligned with the world z-axis. It also disregards the effect of any surface tilt of the green around the rim. The cup model assumes the cup has a diameter of 4.25 inches and a depth of 7 inches. The pin, if present, is assumed to have a diameter of 0.75 inches. Optionally, these measurements can be changed. Because the cup model represents a small, but important, portion of the trajectory, the time step for the cup model can be reduced, such as by a factor of ten, to reduce errors in the simulation.

The cup model begins by calculating the displacement of the center of the ball relative to the center of the cup, in both Cartesian and cylindrical coordinates. Using the cylindrical coordinate theta, it also computes radial and tangential direction vectors. The radial direction is the direction outward from the center of the cup to the point on the cup's wall or rim closest to the ball. Using these vectors, the cup model determines the radial and tangential components of the ball's velocity. If the ball is above the rim of the cup, that is, if the elevation greater than zero, the cup model also calculates the position of the point on the rim closest to the ball, the direction from this point to the center of the ball, and the distance from this point to the center of the ball.

Based on the ball's position and velocity, the subsequent behavior of the ball is categorized. These categories are implemented as internal states of the cup model. The states are ball colliding with bottom of the cup, ball colliding with the pin, ball colliding with the wall of the cup, ball is rolling or sliding along wall of cup, ball is colliding with the rim, ball is sliding or rolling along rim and ball is falling freely. These states are each described.

This ball is colliding with the bottom of the cup when the ball's elevation minus the ball radius is less than or equal to the cup depth and the vertical component of the ball's velocity is less than zero. This state invokes the bounce model, using the surface description of the cup and the unit-z vector as the normal.

This ball collides with the pin if the pin is present, the ball's radial position minus the ball radius is less than the pin radius, and the radial component of the ball's velocity is less than zero. This state also invokes the bounce model, using the surface description of the pin and the radial direction as the normal.

The ball colliding with the wall of the cup state and the ball is rolling or sliding along wall of cup state occur when the ball is below the rim of the cup, that is, the ball elevation is less than zero, and the ball is contacting the wall of the cup, that is, the ball's radial position plus ball radius is greater than the cup radius.

This ball is colliding with wall of cup when the radial component of the ball's velocity is greater than zero. This state invokes the bounce model, using the surface description of the cup and the negative radial direction as the normal.

This ball is rolling or sliding along wall of cup when the radial velocity of the ball is less than or equal to zero. In this state, the cup model calculates the total force and torque on the ball and passes both to the integrator, which determines the position, velocity and spin at the next time step. The total force has three components: gravitational force, normal force from the wall of the cup, and friction force. The total torque is determined by the friction force alone, as both the gravitational and normal forces are directed through the center of mass of the ball.

As described herein, the magnitude of the gravitational force is calculated by multiplying the mass of the ball by the gravitational acceleration constant (9.81 meters per second squared). The direction of the force is straight down. Because the cup is assumed to be vertical with respect to the ground, all of the force is tangential to the wall of the cup.

The normal force keeps the ball from penetrating the wall of the cup. The normal force can be calculated by observing that the normal force is also a centripetal force which causes the center of the ball to travel in a circular path having a radius equal to the cup radius minus the ball radius. The magnitude of a centripetal force is computed by dividing the square of the tangential velocity by the radius of the circular path, while the direction is inward toward the center of the circle. The friction force is calculated using the algorithm described above with respect to sliding friction, with the tangential gravitational force used as an external force.

The ball collides with the rim and the ball is rolling or sliding along the rim when the ball is above the rim of the cup, that is, the ball's elevation is greater than or equal to zero, and the ball is in contact with the rim, that is, the distance from the rim to the center of the ball is less than the ball's radius.

The ball collides with the rim when the dot product of the ball's velocity and the rim direction is less than zero. The state invokes the bounce model, using the surface description of the cup and the rim direction as the normal.

This ball is rolling or sliding along the rim when the dot product of the ball's velocity and the rim direction is greater than or equal to zero. In this state, the cup model calculates the total force and torque on the ball and passes both to the integrator. The total force is composed of the gravitational force and frictional force. The forces are split into a normal component, that is, a component aligned with the vector from rim to ball center, and a tangential component, which is defined by the cross product of the tangent vector and the vector from the rim to the ball center. The friction force is calculated as described above with respect to sliding friction, with the tangential gravitational force and centrifugal force as external forces.

The ball falling freely is the default state, selected when none of the prerequisites for the other states have been met. In this state, the ball is not in contact with the cup or the pin. The total force on the ball is equal to the gravitational force.

The cup model ends when the ball escapes or exits from the cup or is permanently trapped. Escape from the cup detected when the radial displacement of the center of the ball is greater than the radius of the cup. If both the elevation and vertical velocity of the ball are small, the stimulation transitions into the rolling state; otherwise, the simulation transitions into the flying state.

The ball is considered permanently trapped when it is no longer energetic enough to escape the cup. The vertical potential energy of the ball is given by the product of ball mass, gravitational acceleration constant and elevation. Using this formulation, the potential energy is negative when the ball is below the rim of the cup. The vertical kinetic energy of the ball is given by half the product of ball mass and the square of the ball's vertical velocity. If the sum of vertical kinetic and potential energy is less than zero, the ball is permanently trapped.

The energy-test for entrapment relies on the assumption that the cup model can only decrease vertical kinetic energy. For the most part, this is true. The only exception to this assumption is the potential to convert angular momentum into vertical velocity via contact with the cup wall. This conversion, while possible, is assumed to be negligible. Holmes, B. “Putting: How a golf ball and hole interact,” American Journal of Physics 59 (1991): 129-136 provides a good view of the physics involved when a golf ball rolls into the hole, and Penner, A. R. “The physics of putting,” Canadian Journal of Physics 80 (2002): 83-96 includes a correction for sloped greens. In various implementations, the game engine 725 (described below) implements the above described models as described in both papers.

Like the course terrain that virtual objects interact with, additional features, such as surface characteristics of the physical terrain, can be used in the calculation of a virtual object's movement when in contact with the course terrain and when colliding with objects on the course terrain. These features can be used in the equations above to determine the virtual object's direction, speed, spin and acceleration as the virtual object interacts with the model of the physical terrain.

Referring to FIGS. 5B1 and 5B2, a photograph can be divided into general surface types to form a surface type map. The surface types can be bounded by lines drawn to delineate the parts of the hole or by using edge detection techniques on the photograph. The surface type map can itself be mapped onto the portion of the course terrain to which it corresponds. In this way, surface type information can be integrated into the course terrain information. Alternatively, surface types can be directly identified on the course terrain itself.

In the example surface type map, a golf cart path 504, a sand trap 506, a green 508, fairway 510, rough 512 and a pin 514 are each provided with a different surface characteristic. As noted, even though the green 508, fairway 510 and rough 512 are each formed of grass, the ball interacts with each type of grass differently. Specifically, each surface type can have a unique restitution, static friction, kinetic friction, rolling friction and a unique impact parameter. When the roll, bounce and slide of the ball are calculated, the coordinates of the ball's location are matched with the surface type assigned to the coordinates. Of course, each part of the hole can be broken up into further subgroups of surface types, as desired.

In some implementations, a photograph is used as a template to create a surface type map. Alternative implementations allow assigning surface characteristics to the course terrain directly. The photograph has real world surfaces, such as grass, concrete, water, and sand, which are specified in the photograph, such as by drawing a border around each real world object or around groups of real world objects in the photograph (step 560). In some implementations, the real world object delineators are polygons, shapes with curves or other shapes that are drawn over a corresponding surface. Each shape can be filled with a color or pattern, where each color or pattern corresponds with a specified surface characteristic, such as friction and impact parameter values. (Other ways of associating a shape with a surface type are possible). That is, the real world objects in a given photograph are assigned a surface type (step 562) The surface characteristics are then mapped to corresponding areas of the course terrain so that they can be used in calculating virtual object's response to interaction with the course terrain.

In addition to providing the surface types, real world objects in the photograph can be assigned a collision property that affects how a virtual objects reacts when they collides with the real world objects in relation to the course terrain. In some implementations, the collision property is used in two steps of the virtual object trajectory determination process, collision detection and collision response. Whether the virtual object will collide with an object is determined by comparing the trajectory of the ball with any objects in the course terrain that have a collision property assigned to them. If an imminent collision is detected, the ball is moved just prior to the point of collision. In some implementations, the collision response then adjusts the ball's velocity and direction according to the response's parameters and simulation of the ball movement continues.

By way of illustration, two example techniques of marking a photographic image with collision information are described. One technique is referred to herein as a camera image method and it provides pixel accurate collision with a photographic image. The camera image collision method can be used with foreground objects that are perpendicular with the camera and require accurate collision. If the ball appears to move through a collide-able object, such as a tree, in the camera image a collision occurs. This technique involves painting objects in the photographic image in unique colors and adding information to an instruction file, such as an Extensible Markup Language (XML) file, that associates the colors to locations and collision responses. The instruction file and the photographic image can be merged, such as to generate a .png file, to enhance the course terrain, that can be loaded at runtime.

Referring to FIGS. 5C1 and 5C2, the real world objects in the photographic image that can be assigned collision properties are identified (step 564). In one photograph, three palm trees 518 in the foreground are good candidates for camera image collision because they are perpendicular to the camera. The trunks 520 of the trees and the fronds 522 are identified as separate objects so that the trunks 520 provide a different collision responses from the fronds 522. The trunks 520 can be given a hard surface collision response, which causes bounce, and the fronds 522 can be given a soft surface collision response, which causes deflection and energy loss. In some implementations, the center of the fronds stop the ball and cause the ball to fall along a random vector and the tips of the fronds deflect the ball and dampen its speed. Therefore, the location of the ball's collision with a soft object, like tree fronds, can affect how the object changes the ball's trajectory or speed. The real world objects are assigned the desired collision property as described further below (step 566).

Referring to FIG. 5D, in some implementations, the identified objects can be painted into a collision image. Each object can be given a unique color for matching to data in the instruction file. The colors can be shared with all of the photographic images of a hole. Thus, colors are not reused in other collision images for the hole, unless the color is assigned to a different view of the same object. The palm fronds 522 are each given a similar, but different color as are each of the three tree trunks 520. The collision image is saved in a format, such as Graphics Interchange Format (GIF), which stores accurate colors. Other formats are possible, however.

After identifying the real world objects in the photograph, entries corresponding to the objects are added to the information file to identify the position of the object in the course terrain and the collision response assigned to the object. By way of illustration, an example entry can take the form of a tuple: <cameraObject responseId=“1” color=“0xFF0000” xPos=“174.65” yPos=“550.65” zPos=“10.392”/>. The responseId can tie the object to a collision response type defined in the information file. The color is a color in a collision image that corresponds to the object and is expressed using a hexadecimal RGB value. In some implementations, xPos, yPos and zPos are the coordinates of the real world object in the course terrain as determined by automatic analysis of the photograph or through other means. The z position is the altitude at the x and y position. The xPos, yPos and zPos can be determined by locating the object in a top-down view, for example. The position selected can be at the approximate center of the object. These values are used in combination with the camera information to determine the depth of the object in the camera view. The depth calculated for this position can be used for the entire object.

Below is the object definition for the three tree trunks and three sets of fronds in the example information file.

<collision>
<cameraObject responseId=“1” color=“0xFF0000” xPos=“174.65”
yPos=“550.65” zPos=“10.392”/>
<cameraObject responseId=“1” color=“0xFA0000” xPos=“174.825”
yPos=“573” zPos=“11.9607”/>
<cameraObject responseId=“1” color=“0xF50000” xPos=“171”
yPos=“589” zPos=“11.9607”/>
<cameraObject responseId=“2” color=“0x00FF00” xPos=“174.65”
yPos=“550.65” zPos=“10.392”/>
<cameraObject responseId=“2” color=“0x00FA00” xPos=“174.825”
yPos=“573” zPos=“11.9607”/>
<cameraObject responseId=“2” color=“0x00F500” xPos=“171”
yPos=“589” zPos=“11.9607”/>
</collision>

In some implementations, a designer determines which objects are assigned a collision property and assigns the collision property. In some implementations, the system automatically determines which objects should have a collision property without designer input. The system can use a learning algorithm to learn the structure of the golf course from other photographs that have already been assigned collision information. A system that uses a similar learning algorithm to determine vertical structures, sky and ground in photographs is Fotowoosh™, at http://www.fotowoosh.com/index.html.

FIGS. 5E and 5F show the difference between an example collision response for the tree fronds and an example collision response for a tree trunk. A collision with the fronds causes the ball to loose momentum and deflect a slight amount, then fall to the ground, the trajectory 524 indicating the virtual ball's movement through the image. A trajectory 526 for a virtual ball that strikes the trunk 520 shows the ball bouncing off the tree trunk 520.

The camera image collision method is useful for objects that need accurate collision representation to maintain believability. Photographic images are 2-D representations, and like movie props or billboards, they have no additional depth information beyond that calculated from their x, y and z positions. This makes them good choices for objects that are perpendicular to the camera.

The collision layer technique uses an aerial view of the course to show objects at specific positions. The collision layer technique can include painting the real world object's locations in a collision layer. Because the top-down view provides the x and y position, the only additional data necessary is the height of the object and for the collision response to be identified. In some implementations, the height is combined with the course terrain elevation information to create a volumetric object. For example, if a square is painted on the collision layer over a flat area of the course terrain (e.g., a height map) and a color is assigned that indicates a height of three feet, the result would be a three foot tall cube sitting on the height map at the location painted. If the object is on a bumpy area of the height map, the object is roughly cubic but the top surface is bumpy, to match the terrain beneath.

FIGS. 5G and 5H show example steps in creating a collision layer. The objects to be added to the collision layer area identified, here bushes 530 and ground cover 532. Objects that significantly vary in width from the top to the bottom are not good candidates for the collision layer, because the width is calculated from a single top down view. A bush that is roughly cylindrical is a good candidate, but a tree with a thin trunk and a large bushy top is not. Objects grouped together should also have a uniform height. Collision discrepancies can be more visible on objects with hard collision responses than soft.

In the photograph, the bushes are roughly three feet tall and the ground cover is roughly 1 foot tall. Because the bushes are roughly the same height and have roughly the same response, they are each painted the same color and can be handled with the same object definition. The collision layer objects and the camera image objects do not share the same color palette. The collision layer can be exported as a GIF file and can be added to the layer definitions in the information file, for example using the following definition.

<layer id=“collision” feetPerPixel=“0.5”
url=“courses/SkillChallenge/SC_BHGC_H06_C01/
BHGC_H06_Collision.gif”/>

Once the layer has been created and added to the information file, collision objects can be added for each color in the collision layer. An example collision layer object follows:

<layerObject responseId=“2” color=“0x00FF00” height=“3.0”/>

The responseId and color indicate the same things in the collision layer as the collision image. The height indicates the height of the object above the course terrain. Example bush 530 and ground cover 532 definitions are below.

<collision>
<layerObject responseId=“2” color=“0x00FF00” height=“3.0”/>
<layerObject responseId=“2” color=“0x008000” height=“1.0”/>
</collision>

The bushes 530 and ground cover 532 cause the ball to react the same way, because both sets of vegetation deflect a real ball in similar ways. If the response for ground cover is to be different, e.g., if the ball is to stop and the shot declared out of bounds, a new collision response can be created and assigned to the ground cover 532.

At least three different types of collision responses can be provided, hard object collision response, soft object collision response and collisions with artificial boundaries or a boundary collision response. The hard object response is for hard objects, such as tree trunks, rock walls and benches. The parameters can include the ability to set the surface's normal, vary the normal, for example, when a bumpy surface is to be simulated, and to set the amount of energy lost from the collision. The soft object collision response can be used with leafy portions of trees, bushes and ground cover. The parameters can include the ability to set a range of deflection angles as well as the amount of energy lost from the collision. The third response can be used to designate an area on the map that terminates the ball's flight and, optionally, returns the ball to an overridden surface type, such as when the ball goes out of bounds and play of the ball continues from the closest location in bounds.

The hard surface collision response is used to define solid objects. When the ball hits a hard surface, the ball bounces. The attributes of the collision response indicate how the ball bounces. To determine which direction the ball will bounce, the direction the ball is traveling and the normal of the surface with which it will collide are determined. The normal represents the direction the surface is facing and can be calculated in various ways.

The camera image collision calculates normals algorithmically based on the camera parameters and thus the collision response does not need to include one. If the collision response does not include an entry for the normal, it is ignored. Below is a typical hard surface collision response entry with an elastic surface used for a camera image collision.

<hardResponse id=“1” restitution=“1.0f”/>

Collision layer objects can have their normal expressed either by specifying the normal directly or by specifying a position on the course which will be used to calculate the normal. A hard surface collision response used to represent a smooth wall which is facing down the x-axis on the course can be expressed as

<hardReponse id=“2” restitution=“0.8” normalX=“1” normalY=“0” NormalZ=“0”/>.

A position on the course which will be used to calculate the normal can be specified for curved surfaces. The normal is calculated by drawing a ray from the collision impact position to the position specified. Below is a hard surface collision response which uses a normal position:

<hardResponse id=“2” restitution=“0.8” normalX=“1” normalY=“0”
NormalZ=“0”/>.

Once a normal has been calculated, a noise factor can be applied to simulate, a bumpy surface. This is accomplished by providing a rotational range which is used to vary the normal. The range is expressed in degrees and a value is algorithmically chosen between +/− some predetermined value. Below is a hard surface collision response used to represent a wall which is facing down the x-axis but is made of bumpy rocks that will distort the normal by up to +/−5° horizontally and vertically.

<hardResponse id=“3” restitution=“0.8” normalXPos=“133”
normalYPos=“1100” normalZPos=“0”/>

The hard response attributes above are used as follows. The id is the identification of the collisionResponse. The restitution is the amount of velocity reflected by the surface. A value of one indicates no loss of velocity. A value of zero indicates all velocity is lost. The normalX, normalY and normalZ indicates the x, y and z, respectfully, component of the surface's collision normal. The normalXPos, normalYPos and normalZPos, are the real world x, y, and z positions, respectfully, used to calculate the object's normal and can be expressed in feet or other suitable unit. The normal and normal position are not both specified for the same collision response. The normalVar specifies an angular variation to be used to distort the normal and it expressed in degrees.

Soft surface collision responses are used to simulate impacts with surfaces which are not hard enough to cause the ball to bounce but can have some effect on the ball's velocity and direction. Below is an example soft surface collision response used to simulate impact with palm tree fronds. The ball is deflected by +/−10° on the horizontal axis (heading) and +/−5° on the vertical axis (pitch). In addition, the ball's velocity is reduced by 10%+/−5%.

<hardResponse id=“2” restitution=“0.8” normalX=“1” normalY=“0”
normalZ=“0” normalVar=“5”/>

The heading Var is a variable rotation range used to modify the ball's horizontal velocity, expressed in degrees. The pitchVar is a variable rotation range used to modify the ball's vertical velocity, expressed in degrees. The speedReduction is a fixed value used to reduce reduce the ball's speed expressed as a percentage. The speedReductionVar is a variable range used to reduce the ball's speed expressed as a percentage.

The boundary collision response is used to immediately stop the ball and end the trajectory calculation. The final ball position will be at the point the ball intersects an object with the boundary collision response. The final resting location (lie) of the ball will be read from the collision's surface name attribute. Although a similar affect can be accomplished using the surface map, the boundary collision method has one key distinction, it can affect a ball in flight. The surface map is painted on top of the terrain and has no associated height information beyond the height derived from the height map. Therefore, the only time the ball is affected by the surface map is when it bounces or rolls on the terrain.

A boundary collision response, however, can be tied to a layer object or camera image. Both object types sit on top of the terrain and extend upwards. Therefore, it is possible for the collision layer objects and camera image objects to interact with a ball while that ball is in flight and adding an object to the collision layer and associating a boundary response with the lows for stopping the ball in flight or before the ball hits an real world object.

Boundary responses can also be used to help handle balls that fly beyond the range of the surface map. Any ball that bounces or rolls beyond the edge of the surface map is automatically treated as out of bounds. While this is a good default behavior, it may occasionally generate unwanted results. For example on an ocean course, where the ocean extends to the edge of the surface map, a ball that bounces on that edge would return a final lie of water. However, a ball that went beyond the edge of the surface map would return out of bounds. This would not be desirable because from a player's perspective, it would look like the ball hit the water and they would expect the final lie of the ball to be in the water. To solve this, a tall layer object can be created on the edge of the height map and given a boundary collision response with a surface name of “Water.” When the ball impacts the layer object, it stops. Since, the ball would not continue off of the surface map, it would not be treated as being out of bounds. Instead, its Final lie would be derived from the boundary response—in this case in the water.

Below is an example of a boundary collision that acts as an out of bounds area.

<boundaryResponse surfaceName=“Out of Bounds”/>
The surfaceName is the surface type that is reported as the ball's final resting position.

Another piece of information that can be added to a photographic image is the relative distance of various real world objects in the photograph. The actual distances can be seen in an aerial photograph of the course. However, to add the perception of depth to the game, masking can be applied that indicates which objects are closer to the camera and which are further. Additionally, whether the ball would be visible in the camera's line of sight can be determined.

In some implementations, a designer determines which objects are closer to the camera than other objects and adds the information to the photograph or a layer that is added to the photograph by hand. In some implementations, the system determines which objects are in the foreground. The system can use a learning algorithm to learn the structure and layout of the golf course from other photographs that have already been assigned masking information to indicate hierarchical layers of objects. A system that uses a similar learning algorithm to determine vertical structures, sky and ground is Fotowoosh™, at http://www.fotowoosh.com/index.html.

FIG. 5I is a photograph of an example golf hole with trees. The photograph includes a stand of trees along a ridge on both the right side 503a and the left side 503b of the photographic image. In the real world, the ball would not be visible when the ball is at the same height as the trees (along the z axis) and the trees are between the camera and the ball. The ball would also be hidden if the ball were over the ridge. In the virtual world, the trees can be outlined and each outlined area assigned a distance value. Therefore, if the ball is along a vector running from the camera through one of the trees, the ball's visibility can be based on whether the tree between the ball and the camera or behind the ball.

FIG. 5J is an example representation of the trees in the photograph. The representation includes stencils or silhouettes of trees. The trees that are close 542 to the camera overlap the trees that are further 544 from the camera in a two dimensional photograph. In some implementations, the stencils are drawn down to the exact pixel shape of each tree. Bitmap masking can be used, which gives each tree, or other object that is being masked, a single bit depth, which is then given a three dimensional depth property.

FIG. 5K is an example representation of a ball 546 between the camera and the trees that are close 542 to the camera. Because the ball 546 is in front of the trees, the ball 546 remains visible. FIG. 5L shows the ball 546 going beyond a tree that is close 542 to the camera, but falling between the tree that is close 542 to the camera and a tree that is further 544 from the cameral. Thus, the ball disappears behind the closer tree and reappears in front of the tree that is further away 544 when no longer covered by the closer tree 542. Even though the masking does not actually indicate a depth for each tree, multiple layers of trees can provide the illusion of depth. FIG. 5M illustrates another instance when the ball is not in the image. If the terrain has any features, such as hills, that are between the ball and the camera, the ball disappears from view. That means that any obstruction causes the ball to be not visible. If the trajectory 552 of the ball is such that the ball can be seen during at least part of its flight path, but it lands over a ridge 550 or hill, the ball will not be displayed in its landing spot without first changing the image to one where the ball is visible. For example, if the camera angle is not such that the interior of the hole can be seen, the ball disappears as it falls into the hole.

FIG. 5N is a flowchart illustrating how a virtual object can be displayed during play. The photograph that is to be displayed is received (step 570). The receipt of the photograph, such as by a client or other computing system, is described further herein. The photograph is associated with a first discrete shape that is aligned with the real world image in the photographic image. The discrete shape or shapes in have distance values assigned to them. The virtual object is displayed moving in or through the photograph (step 572). The virtual object's trajectory overlaps with the discrete shape when the trajectory's horizontal and vertical coordinates are the same as the discrete shape's horizontal and vertical coordinates. If the trajectory overlaps with a discrete shape associated with the photograph, then whether the trajectory has a distance value greater or lesser than the discrete shape is determined. If the virtual object is along a part of the trajectory that overlaps with the discrete shape and the trajectory has a distance value that is greater than the distance value of the discrete shape, the virtual object disappears or is made to look as if the discrete object obscures the virtual object during the overlap (step 574).

Referring to FIG. 5O, any of the attributes that are assigned to the real world objects in the photographic image can be used to determine the virtual objects movement in relation to, and interaction with, the course terrain. A user provides input indicating how the user wants to control a virtual object, such as an avatar or a ball. The signal that indicates the user input is received (step 580). The movement of the virtual object in relation to the course terrain is determined (step 582). The movement can be based on the user input that is received. The movement is further based on whether the virtual object will collide with a real world object. If the virtual object collides with the real world object, the virtual object's path of movement is changed accordingly to cause the movement to include a collision response. If the determination is made by a server or computer system different from the computer system or client being used by the user, the movement of the virtual object as it has been determined is transmitted to the remote receiver (step 584).

Referring to FIG. 5P, an example method of representing the movement of a virtual object, e.g., a ball, can include showing the interaction of the virtual object with surfaces in photographs. The photograph that is to be presented to the user is received (step 590). A trajectory for the ball moving over and across, or through, the photograph is also received (step 592). The trajectory includes the ball's movement before and after the ball collides with a real world object in the image. If the ball collides with a surface or object, the trajectory includes a change in path that reflects the collision response. The ball is represented moving in the photograph, where the representation is 2D representation (step 594).

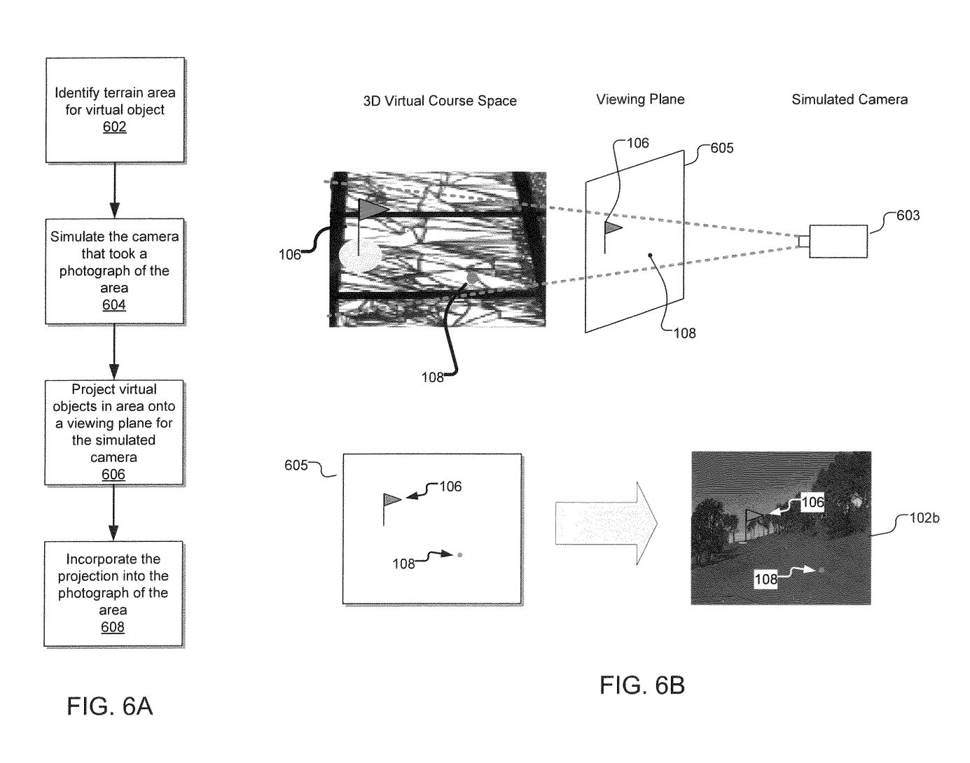

FIG. 6A is a flowchart illustrating an example technique for incorporating a visual representation of virtual objects into a photograph. As described above, a game or simulation engine determines the location of a virtual object in virtual course in relation to the course's terrain. A course terrain area in which the virtual object is located is identified (step 602). Next, the camera that took the photograph for the cell covering the terrain area is simulated (step 604). As shown in FIG. 6B, a virtual camera 603 simulates the exact view 605 of the actual camera based on known parameters of the camera (e.g., the 3D position of the camera, the angle and direction lens, and the focal length of the lens). Using a 3D perspective projection, the virtual object(s) (e.g., ball 108) in the 3D virtual course space are projected into the 2D viewing plane 605 of the simulated camera 603 (step 606). A perspective projection ensures that virtual objects that are farther from the virtual camera will appear smaller in relation those that are closer to the virtual camera, thus adding to the sense of realism. In various implementations, the projection can compensate for visual distortion in the camera lens. The virtual objects in the 2D projection are then incorporated into the actual photograph of the cell (e.g., 102b; step 608). This can be repeated for the same photograph to create an animation of the virtual object. Additional virtual objects (e.g., avatars, virtual equipment) can also be dynamically included to the projection even though the position of these objects may not being used to trigger photographic mapping.

The functionality of a system that incorporates virtual objects into photographs can be segmented into logical components that operate on the same computing device or multiple computing devices connected by one or more networks or other suitable communication means such as shared memory, for instance. A computing device can be a personal computer, server computer, portable computer, cellular telephone, smart phone (e.g., Blackberry), digital media player (e.g., Apple iPod) or other device.

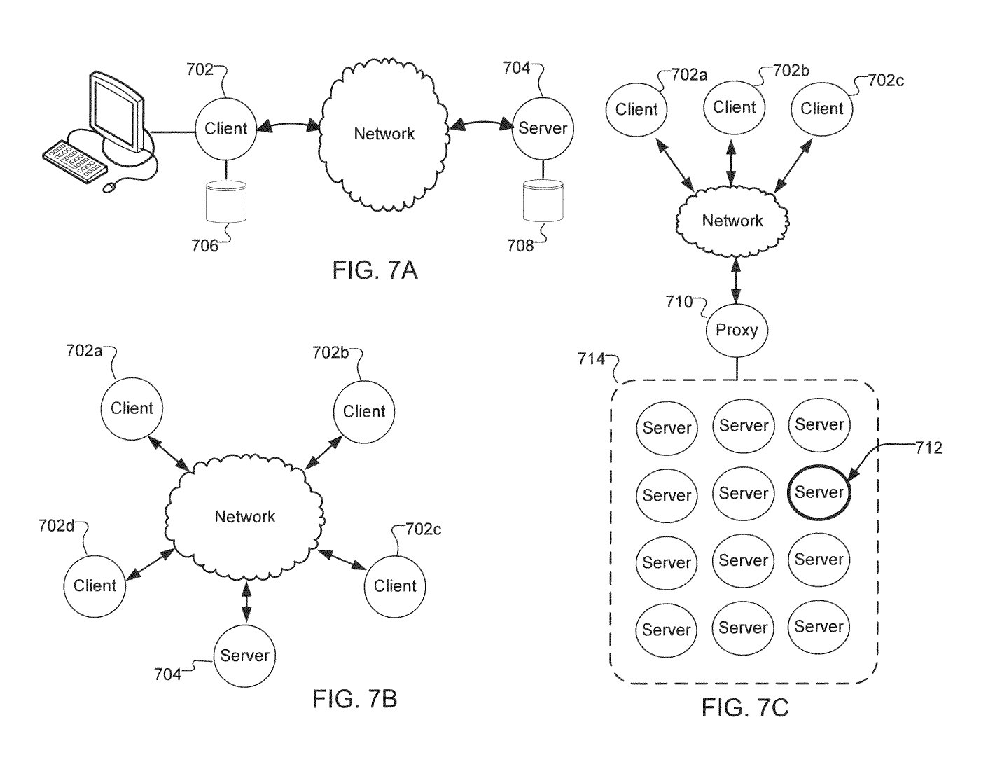

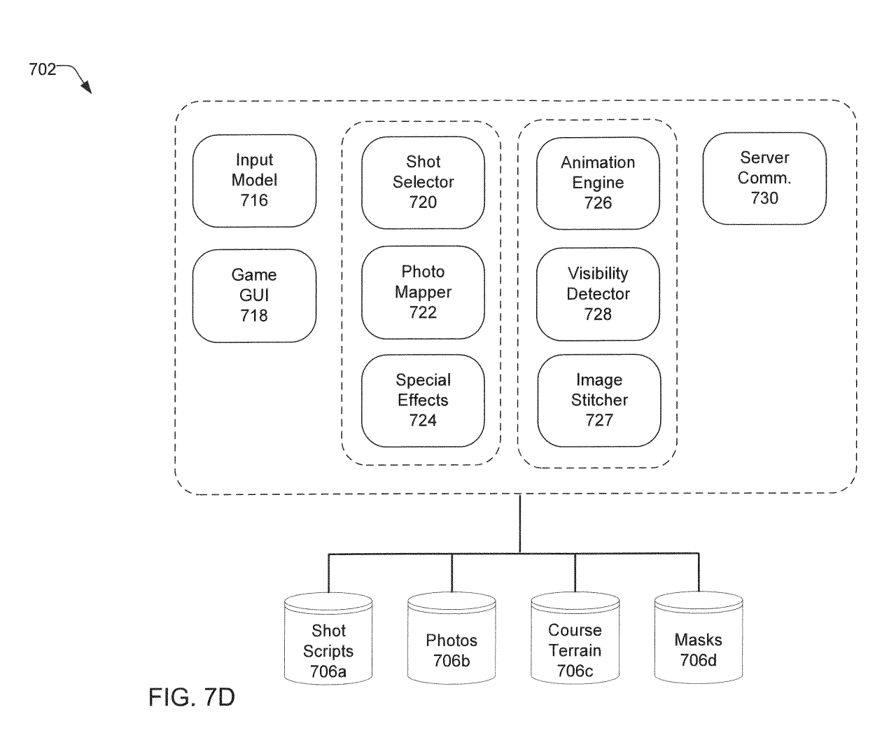

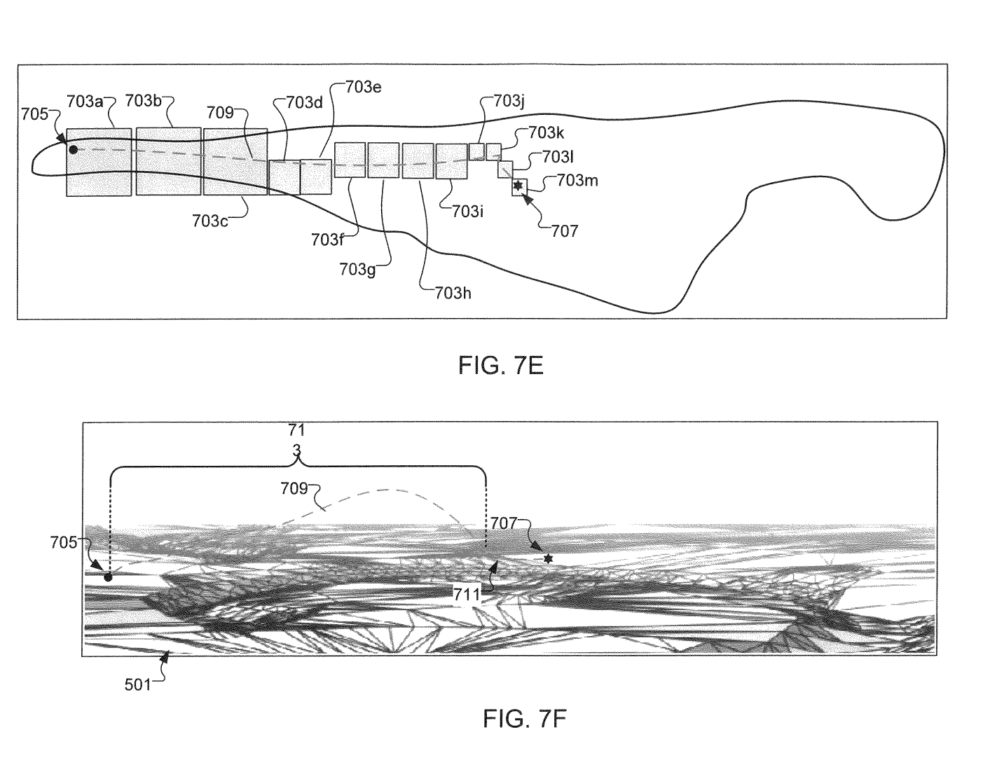

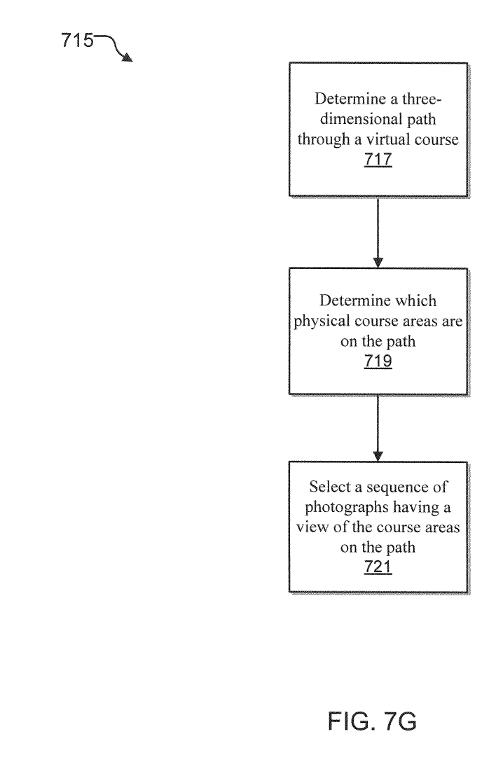

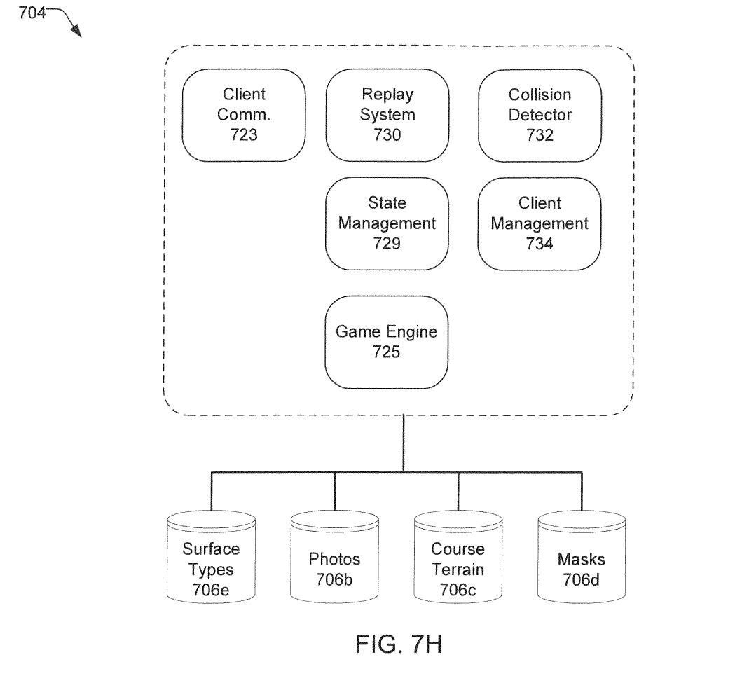

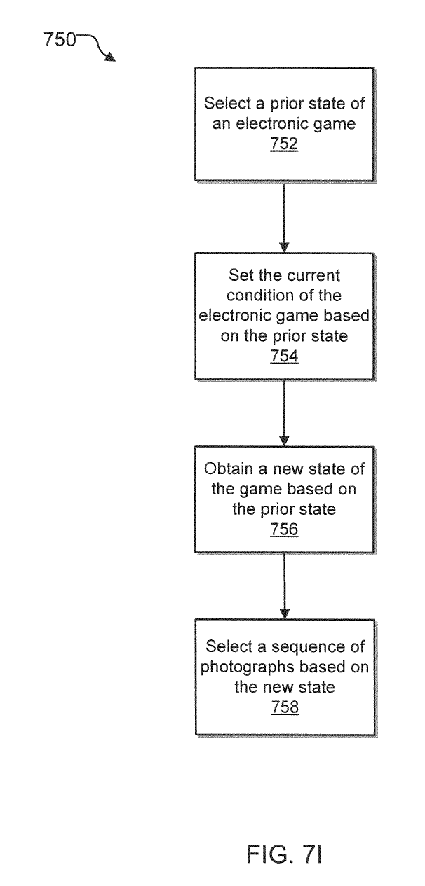

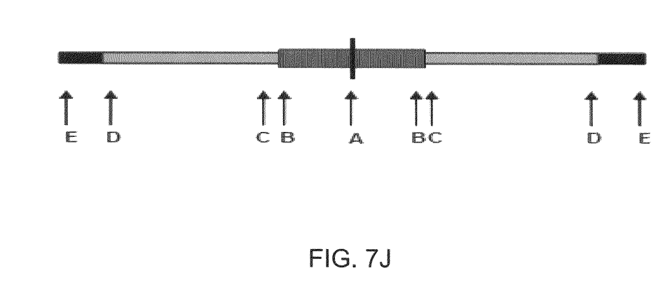

Various implementations exploit an example client/server architecture for the functional components, as shown in FIG. 7A. In this architecture, a server 704 includes functionality for modeling the movement of virtual objects in a virtual course through simulation or other means where as a client 702 includes a GUI (e.g., 100) for obtaining user input, presenting 2D photographs that incorporate visual representations of virtual objects, and enabling user interaction with the photographs. The server 704 utilizes local or remote storage 708 for game assets such as course photographs, course terrain data, game parameters, game state, and other information and provides a subset of this information to the client 702 as needed. In some implementations, the client 702 can obtain needed information from other sources besides the server 704 such as, for instance, content servers or network accessible caches. The client 702 utilizes local or remote storage 706 for caching photographs, course terrain data, and other information received from the server 704.

By way of illustration, a user can provide input such as a golf swing to the client 702's GUI which results in the client 702 sending a signal to the server 704. The communication between the client 702 and the server 704 can be based on a public protocol such as Hypertext Transfer Protocol (HTTP) or a proprietary protocol. In response, the server 704 performs a simulation or other process to determine the path of the virtual ball through the virtual course and returns the client 702 the path, a set of course photographs (if not already obtained by the client 702) that capture the ball's path, and any other information that may be needed by the client 702. The client 702 then incorporates animation of the ball traveling through the photographs based on the ball's path through virtual course.

FIG. 7B is a diagram of an example architecture where multiple clients share a server. In this architecture, the server 704 is able to service a plurality of clients 702a-d. This is possible assuming the server 704's computing resources can accommodate the added computational load of additional clients. This architecture also requires that the server 704 maintain game state and other resources on a per client basis. This architecture allows the clients 702a-d play in the same virtual course, if desired, and allows for other multiplayer features such team forming and competitions between players and teams.

FIG. 7C is a diagram of an example server farm architecture which extends the architecture of FIG. 7B by allowing for multiple servers. A server farm 714 is a cluster or collection of networked server processes running on multiple computing devices. A server process in the farm 714 can service more than one client. When a client 702a-c needs to utilize a server, the client's request is routed to a server proxy 710 instead of an individual server. The server proxy 710 determines which server in the farm is least busy, for example, and assigns the client request to that server (e.g., 712). From that point on, the client can communicate directly with the selected server or the proxy can treat each subsequent request from the client as it did the first request. Server farms also allow for dynamic load balancing. For example, if the performance of server 712 deteriorates due to load, for example, the server 712 or the proxy 710 can move any requests currently pending on the server 712 to a less burdened server. This can occur without the client's knowledge. In some implementations, multiple servers in the farm 714 can cooperate to service a single client request by partitioning computing tasks among them.

FIG. 7D is a schematic diagram of an example client 702. The client 702 includes functionality expressed as software components which may be combined or divided to accommodate different implementations. A game GUI 718 (e.g., 100) can present 2D photographs in which virtual objects are mapped, prompt users for input, and provide users with visual, audio and haptic feedback based on their input, for instance. In various implementations, the GUI is implemented as an Adobe Flash presentation (the Adobe Flash Player is available from Adobe Systems Incorporated of San Jose, Calif.) however other implementations are possible. An input model component 716 interprets user input from one or more input devices as signals. For example, computer mouse input could be interpreted as a golf club backswing signal, a forward swing signal, or a directional signal for pointing a golf club head towards a target such as a golf hole. Signals from the input model 716 are provided to GUI 718 which can, in turn, provide feedback visual, audio, haptic feedback, or combinations of these. By way of illustration, as a user provides input to swing the virtual golf club 112 (see FIG. 1), the virtual club 112 is shown swinging, visual meter 145 is dynamically updated to reflect the progress of the swing, and the user hears the sound of a golf club swing.

Additionally, the signals can be provided to a server communication component 730 which is responsible for communicating with a server 704. The communication component 730 can accumulate signals over time until a certain state is reached and then, based on the state, send a request to the server 704. For example, once input signals for a complete swing have been recognized by the server communication component 730, a request to the server is generated with information regarding the physical parameters of the swing (e.g., force, direction, club head orientation). In turn, the server 704 sends a response to the client 702 that can include a virtual object's path through the virtual course based on the physical parameters of the swing, 2D photographs required to visually present the path by the GUI 718, course terrain information, course masks, game assets such as sounds and haptic feedback information, and other information. The response can be broken into one or more individual messages. In addition, some information can be requested by the client 702 ahead of time. For example, the client 702 can pre-fetch photographs, course terrain information and course masks for the next hole of golf from the server 704 and store them in a photo cache 706b, terrain cache 706c, and course mask cache 706d, respectively.

FIG. 7E is an overhead view of an example virtual course illustrating cells 703a-m on a virtual terrain and along a virtual object path 709 (shown in red) that lies partly above (i.e., in the air) the terrain and partly on the terrain (711) and passes through the cells (e.g., in a path above, on, or below the terrain). A path is an ordered sequence of 3D positions in the virtual course. The path 709 begins at position 705 (e.g., the tee) and ends at position 707. FIG. 7F is a profile view of the example virtual object path 709 in relation to the course terrain 501. As is shown, a portion 713 of the path 709 lies above the terrain 501 and corresponds to when the virtual object is in the air. Each position is within at least one cell for the virtual course since there can be more than one layer of cells for the virtual course. Adjacent positions can be within the same cell or different cells. The distance between adjacent positions in the virtual course can be dependent on the desired resolution of the virtual object's movement or other factors such as cell density. For example, where cell density is high, adjacent positions can be closer to one another or vice versa. Alternatively, the distance between adjacent positions in the virtual course can be a function of the acceleration or speed of the simulated virtual object's movement in the virtual course. Other ways for determining the distance between positions are possible.

The client 702 includes a shot selector component 720 for determining an ordered sequence of photographs (“shot sequence”) that will be presented in the GUI 718 based on photographs of cells that are on or about the path. Cells that are about the path are cells that the virtual object does not pass through but whose associated photographs manage to capture a portion of the virtual object's path through another cell. In various implementations, a shot sequence is created automatically using one or more photographs capturing one or more cells on the path presented along with a static or animated representation of the virtual golf ball mapped from its 3D virtual course positions(s) to corresponding 2D photograph positions(s). The shot sequence presents the photographs in order as though cameras were following the ball from the moment the ball is hit, as it flies through the air, and as it rolls to a resting place on the fairground. The movement of the ball within a photograph is simulated based on the path and the course terrain.

In various implementations, if there is more than one photograph that can be used to show a particular portion of a path (or substantially the same portion of the path), the photograph with the highest priority is selected for the automatically generated shot sequence. Photograph priority is based on one or more factors which are described in TABLE 1. However, other factors are possible.

TABLE 1

| PRIORITY | |
|---|---|
| FACTOR | DESCRIPTION |
| Path location | The photograph showing the path closer to the center |
| in a photograph. | of the photograph is given higher priority. |
| Length of path | The photograph which shows the longest length of a |
| in a photograph. | path portion is given higher priority. |
| Field of view for | Photographs having large fields of view are favored for |
| a photograph. | situations where the ball would be rolling in a |
| | photograph. In yet another alternative, photographs |
| | with smaller fields of view are favored for putting |
| | greens, for example. |
| Landmark in | If there is a course landmark such as a building or a |
| photograph | hazard, photographs showing the landmark are given |
| | higher priority. |

During presentation of the shot sequence users can override which photographs are being shown and select different photographs instead. By way of illustration, if the currently displayed photograph is a ground-based shot of a portion of the path, a user can select an overhead shot of the same portion of the path (e.g., by selecting an overhead camera icon in the GUI 100). In this way, a user can interactively override and dictate a shot sequence. A user can override the entire shot sequence or a portion of the shot sequence. In the later case, the shot sequence will resume to the automatically created shot sequence once the user is no longer overriding.

In various implementations, a shot sequence is created automatically using scripts (e.g., shot scripts 706a), rules or heuristics to select the shot sequence's photographs based on the virtual object path. Such a shot sequence can be generated automatically based on one or more approaches which are described in TABLE 2. Other approaches for generating shot sequences are possible.

TABLE 2

| SHOT | |
|---|---|
| SEQUENCE | |
| GENERATED | |
| AUTO- | |
| MATICALLY | |
| BASED ON | DESCRIPTION |
| Virtual object | For example, if a given portion of the path is in the |
| location | air (i.e., the ball is in flight), overhead photographs of |
| | that portion of the path are favored over ground-based |
| | photographs. Whereas if a portion of the path is |
| | nearing impact with the course terrain, ground-based |
| | photographs are favored. If the path terminates at or |
| | near a hole, an overhead shot of the hole is selected. |
| | If the path comes close to or intercepts a hazard, a |
| | photograph with a large field of view is selected |
| | followed by a photograph showing a close up of the |
| | ball interacting with the hazard's sand or water. |
| Prior user | As a given user interacts with a shot sequence |
| behavior | presentation by overriding which photographs are |
| | shown for different portions of a path, the client 702 |
| | can learn the user's preferences and based on these |
| | determine a shot sequence that will satisfy the user. |
| Prior group | As a group of users interact with a shot sequence |
| behavior | presentation by overriding which photographs are |
| | shown for different portions of a path, the client 702 |
| | can learn the group's preferences and based on these |
| | determine a shot sequence that will satisfy a user who |
| | is a member of the group. |
| Script | Based on a path's starting position, ending position, |
| | intermediate positions, and other factors, a script |
| | 706a can dictate which photographs are selected for |
| | the shot sequence. For instance, the script might |
| | dictate that for positions along a fairway only certain |
| | pre-selected photographs are used in the shot |
| | sequence. |

FIG. 7G is a flowchart 715 illustrating an example technique for shot selection. This technique can be performed by the client 702 or by the server 704, for instance. A three-dimensional path through a virtual course is determined by a simulation or other means (step 717). The virtual course includes a model of a physical terrain for a physical course. The terrain model is used to determine how a virtual object interacts with a virtual course. A determination is made as to which areas of the physical course areas are on the path (step 719). A sequence of photographs is then automatically selected, as described above, which have a view of the course areas on the path (step 721).

With reference again to FIG. 7D, a photo mapper component 722 maps virtual objects in the 3D virtual course to 2D photographs in a shot sequence, as described above in regards to FIGS. 6A-B. The photo mapper component 722 utilizes a visibility detector component 728 to determine whether a virtual object being mapped to a photograph would be visible to the camera. The visibility detector 728 can determine if the virtual camera 603 is unable to see a virtual object due to the object being hidden by the course terrain 501 (706c), such as when a golf ball rolls into a valley or flies over the horizon line. A second way the visibility detector 728 determines if a virtual object is hidden is based on course bitmap masks (706d), as described above. If a virtual object is determined to be hidden, the photo mapper 722 will not show the virtual object in the photograph.

An animation engine component 726 is responsible for animating movement of virtual objects in 2D photographs, such as animating the swing of the avatar 104 and club 112, or animating the golf ball as it flies in the air, collides with objects, and rolls on the ground. The animation engine 726 determines a series of locations for the golf ball in a photograph based on the ball's path through the virtual course. In various implementations, the locations in the photograph can be determined by interpolating between the path positions and mapping the positions to the photograph's coordinate system (e.g., by utilizing the photo mapper 722). Once the series of positions is determined, the golf ball can be animated by rapidly redrawing the golf ball at each position in the series of positions so that the optical illusion of ball movement is created in the viewer's mind. Other objects can be added to a photograph and animated including the movement of a golf flag in the wind, ripples on water, or movement of water such as a waterfall, for example. By way of further illustration, a simulated flock of birds can be added to a photograph such that the flock's animated flight occurs at random times.

A special effects component 724 can be used to enhance photographs by performing image processing to alter the lighting in photographs to give the appearance of a particular time of day, such as morning, noon or evening. Other effects are possible including adding motion blur for virtual objects animated in photographs to enhance the illusion of movement (e.g., the swing of the golf club 112 and the flight of a golf ball 108), shadows, and panning and tilting the virtual camera 603 for effect based on where the ball travels in the photograph to add drama. By way of illustration, the special effects component 724 can tilt the virtual camera up after ball is struck by the virtual club 112 to emphasize the rise of the ball 108.

Sometimes it may be advantageous to combine two or more photographs into a single continuous photograph, such as when the “best” photograph for a virtual object would be a combined photograph, to provide a larger field of view than what is afforded by a single photograph, or to create the illusion that users can freely move through a course. In some implementations, an image stitcher component 727 can combine two or more photographs into a continuous image by aligning the photographs based on identification of common features, stabilizing the photographs so that they only differ in their horizontal component, and finally stitching the images together. The image stitcher 727 can be utilized by the photo mapper 722 or the shot selector 720 to combine photographs.

FIG. 7H is a schematic diagram of an example server 704. The server includes a client communication component 723 which is responsible for accepting requests from clients 702 and providing responses that satisfy those requests. By way of illustration, a request from a client 702 for the path of a virtual object in a virtual course can include parameters that characterize the user's swing of a virtual golf club. The corresponding response to this request would be the path of the virtual golf ball in the virtual course and, optionally, a set of photographs 706b, terrain information 706c and course bitmap masks 706d for areas of the physical course that capture the path of the virtual golf ball. Alternatively, some or all of the information relevant the path can be obtained in separate requests by the client which allows the client to pre-fetch information to improve responsiveness. A given request or response results in the transmission of one or more messages between a client 702 and the server 704.

A state management component 729 maintains the current state of the virtual universe for each user interacting with the server 704 through a client 702. A state includes user input a set of values representing the condition of a virtual universe before the user input was processed by the game engine 725. The set of values include, for example, identification of virtual objects in the virtual universe, the current location, speed, acceleration, direction, and other properties of each virtual object in the virtual universe, information pertaining to the user such as current skill level, history of play, and other suitable information. The state is provided to the game engine 725 as a result of receiving a request from a client 702, for example.

The game engine 725 determines a new virtual universe condition by performing a stimulation based on user input and a starting virtual universe condition. In various implementations, the game engine 725 models the physics of virtual objects interacting with other virtual objects and with a course terrain in a simulated game of golf and updates the user's virtual universe condition to reflect any changes. The game engine utilizes a collision detector 732 and surface types 706e for modeling the collision and interaction of virtual objects, as described above.

A replay system component 730 allows users to “replay” portions of game play and share such with others. This feature is useful when users want to show others how they made a difficult shot, for instance. A client management component 734 maintains for each user a history of states (provided by the state management component 729) and corresponding identifiers. In various implementations, results transmitted to clients can include an identifier of the state that corresponds to the user input and prior values for the virtual universe that were provided to the game engine 725 to create the results. The identifier can be a sequence of letters, numbers or symbols, for example. In some implementations, the identifier is a uniform resource locator (URL). The identifier can be provided to the server's replay system 730 by a client 702 or other process in order to “replay” a simulation. The replay component 730 uses the identify to locate the corresponding state and then provides the state to the game engine 725, resulting in a “replay” of the user input for the state. The identifier can also be shared among users through electronic mail, instant messaging, or other means.

FIG. 7I is a flowchart of an example method 750 for replaying a simulation. A prior state of a virtual universe is selected from a plurality of prior states based on a received identifier by the replay system 730, the prior state including user input previously provided to the electronic game and a set of values representing the condition of the virtual universe before the user input was processed by the game engine 725 (step 752). The current state of the electronic game is set according to the prior state by the replay system 730 (step 754). A new state of the virtual universe is obtained based on processing of the user input by the game engine 725 and the set of values (step 756). Alternatively, the new state is merely obtained from the client management component 734 as the state following the prior state in history of states. A sequence of photographic images based on the new state is selected (step 758).

The game engine 725 includes various workings for modeling the physics of the virtual golf ball travel (e.g., flight, impact, bounce, roll) in the virtual course. Hereinafter, the virtual golf ball will be referred to as merely the ball. In various implementations, forward Euler integration is used to simulate discrete time steps during simulation of ball movement in the virtual course. At each step, the current dynamic model will calculate velocities and accelerations and apply them linearly over the interval of the step size. In further implementations, fourth order Runge-Kutta method for integration can be used.

The time step defines the amount of time that is simulated by each step of the integrator in the game engine 725. The choice of time step balances accuracy with computational complexity: a smaller time step reduces the error introduced by the integration function but increases the number of simulation steps required. If a maximum velocity for the ball is assumed, the choice of time step can be used to limit the distance traveled by the ball during each simulation frame. The time step resolution on the client 702 and the server 704 should be the same so that calculated trajectories of virtual objects are identical.

The ball model has a radius and a mass. The United States Golf Association (USGA) rules specify the minimum diameter of the ball as 1.68 inches (0.0427 meters). A British ball is slightly smaller, with a diameter of 1.62 inches (0.0411 meters). These correspond to radii of 0.02135 meters and 0.02055 meters, respectively. The USGA rules specify the maximum weight of the ball as 1.62 oz (0.04593 kg). The ball also has a moment of inertia which is a scalar quantity, measured in kg m², which describes the ball's inertia with respect to rotational motion about its central axis. If the ball is modeled as a solid sphere of uniform density, the moment of inertia is given by the following equation:

$$I = \frac{2}{5} {MR}^{2} = 8.3743 \cdot {10}^{- 6}$$

The actual moment of inertia varies, generally depending on how the ball was constructed and how it is designed to behave. The coefficient of restitution is a dimensionless constant that describes the amount of momentum lost when the golf ball collides with a solid surface due to deformation, heat, sound, etc, and can be represented as a function of the impact speed. The following equation is for the coefficient of restitution of a golf ball colliding with a club face: e=0.86−0.0029vᵢ, where vᵢ is the impact speed.

The coefficient of lift is a dimensionless constant that describes the amount of lift force generated by a golf ball. It is used by the flight model. It is parameterized by the velocity of the ball through the air and the spin rate of the ball. The coefficient of drag is a dimensionless constant that describes the amount of drag force generated by a golf ball. See description of coefficient of lift, above, for more details. The coefficient of friction describes how much resistive force is generated by sliding a golf ball along a surface. This value is used by the clubhead impact model and the rolling model.

The clubhead model assumes that friction is sufficient to cause the ball to begin rolling before leaving the clubhead. The coefficient of friction is estimated at 0.40, although this can vary. Ball position is a vector quantity, measured in meters. Ball velocity is a vector quantity measured in meters per second. Velocity ranges from a maximum of about 75 m/s for a drive by a professional golfer to about 26 m/s at the end of a drive to 1.63 m/s for the maximum speed that can be captured by the hole when aimed directly at the center. The angular velocity of the ball is a vector quantity, where the direction defines the axis of rotation and the magnitude defines the rotational speed, in radians per second.

The position, velocity, and angular velocity of the ball are stored in the inertial reference frame (i.e. relative to the course terrain), though dynamic models may shift it into other frames of reference to simplify certain calculations.

There are two generally types of golf balls: two-piece versus three-piece (or wound) balls. Two-piece balls are made from a solid core with a durable synthetic cover. They are less expensive and more durable than three-piece balls. Because of the harder cover, they tend to travel farther and spin less than three-piece balls. Three-piece balls are made from a solid or liquid core, surrounded by a rubber winding and wrapped in a softer “balata” cover. The softer cover is susceptible to nicks and cuts, which makes the balls wear faster. Three-piece balls don't travel as far as two-piece balls, but the soft cover allows them to achieve higher spin rates at launch and hold the green better upon landing. Two-piece balls have a higher moment of inertia, lower coefficient of friction, and higher coefficient of restitution. Three-piece balls have a lower moment of inertia, higher coefficient of friction, and lower coefficient of restitution.

A club model includes a clubhead mass which is a scalar quantity, measured in kg. Clubhead mass can also be estimated from the swing weight of the club. Loft is a scalar quantity that describes the angle the clubface forms with the vertical, measured in radians. A club with low loft has a nearly perpendicular face, like a driver or a putter. Irons and wedges have very high lofts, which imparts generates a higher trajectory with more backspin.

The coefficient of restitution describes the amount of momentum lost during the clubhead's impact with the ball. The clubhead's coefficient of restitution has a minor effect compared to the ball's coefficient. Some clubs incorporate a feature known as “spring-like effect”, where the club face is designed to deform and return energy to the ball upon launch. Spring-like effect is modeled as a constant positive percentage modifier to the ball's coefficient of restitution.

Shaft length is a scalar quantity describing the distance of the clubhead from the grip, measured in meters. This value is used by the swing model to determine clubhead speed. A longer shaft generally increases clubhead speed at the expense of accuracy. An atmosphere model uses data found in a typical weather report to calculate the atmospheric density, which is used in the flight model to calculate drag and lift. It also models the presence of wind. Pressure is a scalar quantity, measured in millibars (mbar). Temperature is a scalar quantity, measured in degrees Celsius (C).

Humidity describes the quantity of water vapor present in atmosphere. It can be specified as either relative humidity or dew point. Relative humidity describes the amount of water vapor present relative to the total amount the air can hold at the current temperature (the saturation pressure). Dew point describes the temperature at which the current amount of water vapor would completely saturate the air. Dew point has the advantage of remaining constant despite shifts in the ambient temperature.

Density expresses the amount of mass per unit volume, measured in kg/m³. The density is calculated from the input values for pressure, temperature and humidity using the following equation:

$$D = ( \frac{{P}_{d}}{{R}_{d} \cdot {T}_{K}} ) + ( \frac{{P}_{v}}{{R}_{v} \cdot {T}_{K}} )$$

where

D=density (kg/m³)

P_{d}=pressure of dry air (Pascals)

Pᵥ=pressure of water vapor (Pascals)

R_{d}=gas constant for dry air=287.05 J/(kg*degK)

Rᵥ=gas constant for water vapor=461.495 J/(kg*degK)

T=temperature (degK)=degC+273.15

The saturation pressure of water vapor can be calculated for a given atmospheric temperature using the following equation:

$${E}_{s} = {c}_{0} \cdot {10}^{\frac{{c}_{1} \cdot {T}_{c}}{{c}_{2} + {T}_{c}}}$$

where

Eₛ=saturation pressure of water vapor (mbar)

T_{c}=temperature (degC)

c₀=6.1078

c₁=7.5

c₂=237.3

The pressure of water vapor, Pᵥ, can be calculated from the dew point by simply substituting the dew point in the equation above. To calculate the pressure using relative humidity, the saturation pressure for the current temperature is calculated and multiplied by the relative humidity percentage. Finally, the pressure of the dry air, P_{d}, can be calculated by subtracting the pressure of water vapor from the absolute pressure. Substituting the values for P_{d} and Pᵥ into the first equation yields the atmospheric density. The reference value for atmospheric density is 1.2250 kg/m³, which assumes dry air at a pressure of 1013.25 mbar and temperature of 15 degC.

Wind is represented as a function of time and position which returns a vector quantity indicating the direction and speed of the wind in meters per second. Wind direction and speed may vary with time, but it is assumed that the wind is the same everywhere on the course. In the real world, wind speed usually decreases close to the surface of the ground. This model builds on the previous model by defining a height below which the wind vector is scaled linearly to zero. This implies a dependency from the atmospheric model on the height map. Wind is often shaped by local geographic features, like hills or valleys. These features may affect not only the wind speed, but also its direction. To represent the local variations, a wind vector can be stored for each point on the hole. Such a vector field can be implemented by placing an image map over the height map for the hole and using the three channels of the image map to represent the components of the wind vector along each axis.

The encoded vectors could represent absolute wind vectors or a relative offset from a global wind vector. Each vector field would be closely tied to a prevailing wind direction. (Consider, for example, the wind shadow cast by a hill.) The underlying wind speed and direction can be driven by a noise function, parameterized by time. The inputs to the noise function should allow course designers to specify a prevailing wind direction and speed and a range around each. This will be implemented using either a random walk with shaped probabilities or a Perlin noise function.

A course model uses a height map which is a bitmap image with greyscale color values to define a regular grid of elevation samples corresponding the course terrain or topology. This elevation data will be interpolated using either bilinear or bicubic interpolation.

The lie describes how far the ball has sunk into the surface of the course. It will be measured in meters or as a percentage of the ball's radius. A deeper lie requires the clubhead to dig deeper into the surface material of the course, which reduces the clubhead speed at impact. Also, a deeper lie raises the point of impact between ball and clubface, which affects spin rate and launch angle. The effect of lie will depend on the particulars of the swing and clubhead impact models, and may require additional work.

The swing model describes how the golfer swings the club. Inputs include variables from the GUI (player input), swing type, club parameters, and any game stats for the golfer. The primary output of the swing model is a set of dynamic parameters for the club in the instant that it hits the ball. These include clubhead speed and direction, impact point on the ball and clubhead and the dynamic loft of the clubface. These parameters are fed into the clubhead impact model, which generates the initial conditions for the trajectory of the ball.

In various implementations, swing is modeled as a double pendulum composed of the golfer's arms and club. Forces, torques and couples are applied to the double pendulum to generate the final motion of the clubhead at impact. While the double pendulum model offers interesting insights into how to improve a golfer's swing, it's not the best model for a game. The connection between input variables and output variables is not intuitive at all.

In other implementations, a results-based model that allows the parameters to be set directly. The golfer will have a maximum power, which represents either the maximum clubhead speed (for maximum clarity) or the amount of work the golfer is able to do with a club (e.g., to adjust for clubhead weights and shaft lengths.)

The purpose of the swing model is to compute the initial parameters of a golf ball's trajectory after being struck with a club. The model has two main phases. The first phase determines the position, velocity, and orientation of the clubhead at impact based on player inputs as well as equipment and environmental parameters. This phase is further subdivided into three separate models to represent the physical swing motion, the presence of golfer error, and interactions of the club with the ground.

After the first phase, the state of the clubhead is completely described and the second phase begins. Here, the impact between the clubhead and ball is modeled as a rigid-body collision. From the collision model, the linear and angular velocity of the golf ball can be determined.

The trajectory of the golf ball is completely determined by two vector quantities: linear velocity and angular velocity. The linear velocity describes the motion of the ball's center of mass, while the angular velocity describes the rotational motion. (The direction of the angular velocity vector gives the axis of rotation and the magnitude gives the speed of rotation.) Subsequent behavior of the ball during flight is determined by atmospheric interactions like lift and drag but the overall trajectory is completely determined by these two initial vectors. Taken together they can describe any possible draw, fade, hook, slice, etc.

TABLE 3 below gives sign and rough magnitude for both deflection and sidespin for some common ball trajectories. Since a right-handed coordinate system is used, positive angles and rotations are counter-clockwise. Positive horizontal deflection is a pull, while negative is a slice. Positive sidespin causes a hook, while negative sidespin causes a slice.

TABLE 3

| TRAJECTORY | DEFLECTION | SIDESPIN |
|---|---|---|
| Straight | 0 | 0 |
| Fade | Positive (small) | Negative (small) |
| Hook | 0 | Positive (medium) |
| Pull | Positive (medium) | 0 |
| Push-Hook | Negative (medium) | Positive (large) |
| Pull-Hook | Positive (large) | Positive (medium) |
| Draw | Negative (small) | Positive (small) |
| Slice | 0 | Negative (medium) |
| Push | Negative (medium) | 0 |
| Pull-Slice | Positive (medium) | Negative (large) |
| Push-Slice | Negative (large) | Negative (medium) |

The common golfing terms can be related to the vector velocities by defining an appropriate coordinate frame and using some basic trigonometry. If v represents linear velocity, ω represents angular velocity, and the target, or aim point, is on the x axis, the following relationships hold:

$$\begin{matrix}• Launch speed = \vert v \vert = \sqrt{{v}_{x}^{2} + {v}_{y}^{2} + {v}_{z}^{2}} \\ • Launch angle = θ = {sin}^{- 1} ( \frac{{v}_{z}}{\vert v \vert} ) . \\ • Horizontal deflection = ϕ = {tan}^{- 1} ( \frac{{v}_{y}}{{v}_{x}} ) \\ • Backspin = - {ω}_{y} \\ • Sidespin = {ω}_{z}\end{matrix}$$

The purpose of the arm model is to use player inputs, equipment parameters and surface parameters to compute the velocity and orientation of the clubhead at impact. The arm model assumes a perfect swing; this assumption is later revised by the outputs from the error model before entering into the collision response model.

In physics, the golf swing is typically modeled as a double pendulum. The lower pendulum represents the club, while the upper pendulum represents the golfer's arms. At the end of the swing, immediately before impact, both pendulums are relatively aligned with similar velocities. In various implementations, the double pendulum model is collapsed into a single pendulum model, consisting of the shaft combined with the arms. Using this model, reasonable approximations for the state of the clubhead just prior to hitting the ball can be determined.

To further simplify the model, the calculation of swing speed is based on a reference swing with known equipment. By calculating the difference between the current equipment and that used for the reference swing, the difference between the swing speeds can be calculated. This avoids a more complicated model of muscles and joints or torques and couples.

The geometry of the arm model uses the concept of the swing plane. This is an imaginary plane defined by the line from the ball to the target and the line from the ball to the golfer's shoulders. On a good swing, the clubhead stays within this plane during its entire arc. The motion of the clubhead near impact can be visualized as following a large circle, tilted to pass through the golfer's shoulders. The radius of this circle is determined by adding the golfer's arm length and shaft length. The arm length can be specified directly, or computed using a formula based on the golfer's height (16.1 times height in inches divided by 72).

The tilt of the swing plane depends on the terrain. If the ball is on a flat surface, the tilt is roughly equal to the lie angle of the club. A sidehill lie, however, can increase or decrease this angle. If the ball is higher than the golfer's feet, the swing plane becomes more horizontal. If the ball is lower than the golfer's feet, the swing plane becomes more vertical.

The angle of the lie is determined by sampling the golf course elevation at three points corresponding to the ball and the golfer's left and right feet. Foot position is determined calculating the offset of the feet from the aim line (cosine of lie angle times sum of arm length and shaft length) and assuming a stance width of two feet. Taking the cross product of the vector from ball to left foot and the vector from the ball to the right foot gives the normal of the triangle, from which can be computed both uphill and sidehill lie angles. As noted above, for a sidehill lie, the golfer adjusts by tilting the club up or down to match the difference in elevation. For an uphill or downhill lie, however, it can be assumed that the golfer attempts to keep his body perpendicular to the slope. The swing arc, therefore, is tilted along the aim line to match the slope of the ground.

The swing arc model obviously breaks down for extreme lie angles. For example, consider playing a shot with the ball on the lip of a coffin bunker, with the aim line perpendicular to the lip. The lie angle would be computed as an extreme uphill lie, and the assumption that the golfer's body remains perpendicular to the slope would require him to lean more than forty-five degrees to the right. This is clearly unrealistic.

The forward and back position of the ball in the stance determines the point in the swing arc where the clubhead makes contact. In various implementations, ball placement is defined relative to the low point in the swing arc, which moves depending on the type of swing. Placing the ball behind the low point causes the clubhead to strike it while the clubhead is still descending, while placing the ball ahead of the low point causes the clubhead to strike it when the clubhead is ascending.

In various implementations, ball placement, measured in units of distance, is converted into an angular measurement, using the radius of the swing arc. In the discussion below, this angle is called theta. Theta is positive when the ball is moved forward and negative when the ball is moved backward, consistent with our right-handed coordinate system.

The velocity of the clubhead at impact is based on its speed and direction. As mentioned above, clubhead speed is computed based on the reference swing. Direction is determined by the tangent of the swing arc at the point where the clubhead contacts the ball.

The reference speed provided for the golfer is his swing speed with a standard driver. This assumes a shaft length of 44 inches and a clubhead mass of roughly seven ounces. From the swing speed and radius, the angular velocity can be calculated in radians per second. In various implementations, it is assumed that this angular velocity is constant for all shaft lengths and has an inverse linear relationship with clubhead mass. (i.e., the same golfer swings a heavier clubhead more slowly than a lighter one.) Multiplying the angular velocity by both the shaft length and the ratio of current clubhead mass to reference mass gives us the clubhead speed at impact.

The clubhead velocity vector can be determined by calculating the direction of the tangent of the swing arc at theta and multiplying by the speed.

The orientation of the clubhead is determined by several factors. Some are controlled directly by the player, while others result from equipment or environmental conditions. Note that orientation in this section refers to the rotation of the entire clubhead, rather than the clubface, which is affected by things like loft, bulge and roll.

The most significant input is the swing arc, which incorporates the player's chosen aim line. For a perfect swing on level ground, the clubhead is presented in a level and neutral—neither open or closed—orientation, perpendicular to the aim line. The other player inputs act as modifiers to this basic stance.

Ball placement modifies the position in the swing arc where contact is made. If theta is negative, the clubhead will be tilted downward and opened slightly. If theta is positive, the clubhead will be tilted upward and closed slightly.

Opening or closing the stance will affect the z-axis of the clubhead, turning the clubface across the line of motion. Another option is open or closing the club itself, by rotating the handle. This affects both vertical and horizontal rotations of the clubhead.

Additional inputs, not controlled by the player, also affect the orientation. One major factor is shaft flex. At the start of the downswing, the flexible shaft bends backwards as the hands accelerate the heavy mass of the clubhead downward. Near the end of the downswing, however, the golfer's wrists release, transferring energy from arms and wrists into the clubhead. This slows the hands, relative to the clubhead, and causes the shaft to flex the opposite direction, which tilts the clubhead upward. This tilt causes the “dynamic loft” of the clubhead to be several degrees greater than clubface loft.

Shaft flex is modeled based on the mass and velocity of the clubhead, however other models of shaft flex are possible.

Lastly, the angle of the lie can affect the orientation of the clubhead. A sidehill lie tilts the swing plane, which affects the heel-toe level of the clubhead. Since the swing arc is defined in relation to the surface, uphill and downhill lies affect the tilt of the clubhead in world coordinates.

The purpose of an error model is to represent deviations from the perfect swing. The error model combines inputs from the swing meter and attributes from the gaming system to determine the type and amount of error to introduce. The error model generates a set of modifiers that are applied to the outputs from the arm model to determine the actual state of the clubhead just before striking the golf ball.

A golf swing is a complicated motion with many opportunities for error. Trying to model individual errors during the swing would be prohibitively complicated, as well as difficult to tune and control. Fortunately, almost all errors can be grouped into a relatively small number of categories based on their effect on the impact between club and ball. Instead of modeling individual errors in the swing, the resulting effects are modeled directly. The major error types are detailed in TABLE 4.

TABLE 4

| ERROR TYPE | DESCRIPTION |
|---|---|
| Speed Error | The golfer may swing the club more quickly or slowly than he |
| | intended. This will primarily affect the launch angle and |
| | distance of the shot, with a secondary effect on spin. Speed error |
| | can be measured as a percentage of desired club speed. |
| Directional Error | The golfer may swing the clubhead through the ball in a slightly |
| | different direction than he intended. Assuming the face is kept |
| | square to the direction of motion, the resulting shot will either be |
| | pushed or pulled. Directional error can be measured in degrees, |
| | with positive to the left. |
| Orientation Error | The golfer may fail to align the clubface squarely with the |
| | direction of motion. This produces sidespin, which will result in |
| | a hooking or a slicing trajectory. Orientation error is measured |
| | in degrees of rotation away from square, relative to the direction |
| | of motion. A positive value represents a closed clubface, while a |
| | negative value represents an open clubface. |
| Positional Error | The golfer may hit the ball somewhere other than directly in the |
| | center of the clubface. This causes the clubhead to rotate during |
| | the impact, which robs the shot of power. Depending on the |
| | clubhead parameters, the ball may also be pushed or pulled, and |
| | sidespin may be produced. Positional error can be measured in meters. |

Interactions between the clubhead and the ground can result in additional types of error. These types of interactions can be handled by the ground model.

There are two main sources of error in the swing model. The primary source of error is the swing meter. The secondary source of error is essentially random, intended to represent the inherent difficulty of properly executing a perfect swing. Random errors should be significantly smaller than those introduced by the swing meter, to keep players from feeling the game is too unpredictable or “cheating”. Both sources of error should decrease as the golfer becomes more experienced.

The swing meter is the primary interface for controlling a golf swing (see FIG. 7J). The location of the final click determines the types and amounts of error that are applied to the shot. This user interface element gives the player direct control over shots and provides clear, unambiguous feedback whether a swing was successful.

The types of errors described above suggest a basic set of player attributes. These could be further subdivided based on club type, surface type, etc. For the initial skill challenge, however, the gaming attributes will be directly linked to the error types.

The amount of error for each type is calculated based on the swing meter and a random input that simulates the normal probability distribution function. The regions of the swing meter between the points indicated by D are each represented as a number in [−1.0, 1.0]. The number corresponding to the region between the points indicated by Bin FIG. 7J is named S1, and the number corresponding to the region between the points indicated by C and D is named S2. To preserve continuity between regions, S1 has a magnitude of 1 when the S2 is non-random zero. The normal input ranges from [−1.0, 1.0] and is named R. Each gaming attribute consists of three coefficients, which are applied to S1, S2, and R to determine the final error amount using the formula error=k1*S1+k2*S2+k3*R.

This formula allows any error type to be linked to the swing meter and provides a simple linear range across each region of the swing meter. The linear relationship may need to be replaced by a curve, but the shape of the curve has not yet been specified. This should suffice for the skill challenge, but may need to be revised for the full game. The formula may also need to be expanded to include other terms—power, for example.

In various implementations, between A and B small amounts of directional error are added. This causes the shot to have a slight push/pull. Between C and D, the magnitude of directional error increases, and moderate amounts of orientation error are added as well to provide hook and slice. (The region between D and E can be handled by a special case.) This corresponds to the following coefficients in TABLE 5.

TABLE 5

| | ERROR TYPE | | |
|---|---|---|---|
| | K1 | K2 | K3 |
| Direction | Small | Small | 0 |
| Orientation | 0 | Moderate | 0 |

The purpose of a ground model is to represent interactions between the clubhead and the ground. The outputs of the ground model are a set of modifiers to the clubhead velocity and orientation, as well as clubface friction, based on the degree of contact between the clubhead and ground surface. The degree of contact is estimated using the trajectory of the clubhead and certain clubhead parameters. The relationship between inputs and outputs is defined for each different surface type.

The set of input variables to the model should allow similar choices as when playing a difficult lie in the real-world. For example, when hitting from deep or “nesty” lies, golfers are advised to “hit down” on the ball. Using a descending swing has two beneficial effects. First, the steep trajectory minimizes the amount of contact with the ground before the ball, which maintains clubhead velocity. Second, the steep trajectory minimizes the amount of grass or other material that can be pinched between the ball and clubface, which maintains clubface friction.

Each modifier can have its own formula with a different set of inputs. One common input is the amount of contact between the clubhead and the ball. This can be estimated using the depth of the ball's lie, the ball placement in the stance, and the swing arc, and normalize it to a range between zero and one, suitable for scaling other values. The output modifiers are described below in TABLE 6.

TABLE 6

| OUTPUT | |
|---|---|
| MODIFIER | DESCRIPTION |
| Decrease in | Friction between the clubhead and the ground causes the |
| clubhead | clubhead to slow down. Surfaces like sand and water cause |
| velocity | high amounts of drag, while other surfaces like fringe and |
| | rough cause relatively less drag. The amount of drag is |
| | generally proportional to the amount of contact between the |
| | clubhead and ground. For fluid and semi-fluid surfaces like |
| | water and sand, the shape of the clubhead also plays a role; |
| | low-lofted clubheads displace more material than thinner, |
| | higher-lofted clubheads, so low-lofted clubheads experience |
| | more drag. As with any fluid resistance, drag also increases |
| | with velocity, so a fast-moving clubhead will lose more |
| | velocity than a slower one. Input variables: amount of |
| | contact, clubhead loft, clubhead velocity. |
| Change of | If the clubhead is not level when it contacts the ground-on |
| clubhead | a side hill lie, for example - it may experience uneven |
| orientation | amounts of drag. If the toe or heel contacts the surface more |
| | firmly than the opposite end, it will experience increased |
| | drag and the clubhead will rotate around the vertical axis. |
| | This can cause hooks and slices. Input variables: amount of |
| | contact, clubhead orientation, clubhead velocity. |
| Decrease in | Friction between the clubface and ball can be reduced when |
| clubface | hitting from deep, juicy roughs. As the clubhead passes |
| friction | through the grass, moist debris may accumulate on the face |
| | of the club. This debris lubricates the clubface, decreasing |
| | friction. The decreased friction causes the ball to leave the |
| | clubface with less backspin, which affects green-holding; it |
| | also may slightly increase the height of the trajectory. |
| | Grooves on the clubface help to trap this debris, which |
| | keeps the clubface clear and maintains friction. Input |
| | variables: amount of contact, clubhead grooves. |

The ground model currently does not include a modifier to represent clubhead bounce on hardpan lies. This can be added if desired, but it introduces a level subtle variability that may not be understood by players.

The purpose of a collision response model is to calculate the linear and angular velocity for the ball after being hit with the club. The model combines the outputs from the arm model, error model, and ground model to determine the position, orientation and velocity of the clubhead just before impact. The impact between ball and club is modeled as a rigid body collision. Both club and ball are treated as free bodies, which allows us to apply the conservation of momentum and Coulomb's friction laws to determine a reasonable approximation of the physical state after the collision.

The impact between a golf club and a golf ball is a remarkable violent event. When driving from the tee, for example, the clubhead, which is traveling somewhere between 70 and 120 miles per hour, strikes a stationary ball. The ball compresses against the clubface then springs back, launching the ball at speeds in excess of 150 miles per hour. The entire collision lasts only half a millisecond, during which the force between the clubface and ball averages 1400 pounds.

Because the clubface is tilted, the ball also starts sliding up the clubface during the collision. This sliding generates a frictional force, applied tangentially at the contact point in the opposite direction of the sliding. The friction causes the ball to rotate. If the combination of normal force and coefficient of friction is high enough, the ball will begin to roll before it leaves the clubface. This rotation causes backspin.

If the clubface is not aligned with the direction of motion, the tangential velocity will have a horizontal component as well. This horizontal component will cause the ball to rotate around a vertical axis, causing sidespin and a resulting hook or slice.

If the ball strikes the clubface off-center, the normal force between the clubface and ball will cause the clubhead itself to start to rotate. This rotation has several effects. First, it robs the shot of some power; energy is transferred into the angular momentum of the clubhead instead of the linear momentum of the ball. Second, the rotation turns the clubface in a new direction which has a slight affect on the subsequent motion of the ball. Lastly, the rotation of the clubhead creates a tangential velocity between the ball and clubface. This tangential velocity causes a frictional force to arise, which causes the ball to spin in the opposite direction to the club. This is the so-called “gear effect”.

In addition to the vectors describing the velocity and position of the clubhead, the collision response model also uses the following physical properties of the club as described in TABLES 7 and 8.

TABLE 7

| CLUB VARIABLE | DESCRIPTION |
|---|---|
| Mass | The clubhead mass is used to determine the total momentum of |
| | the system before the collision. Increasing the clubhead mass |
| | generates high launch speeds. It also stabilizes the clubhead |
| | against off-center hits. (See the arm model for further discussion |
| | of clubhead mass.) |
| Moment of Inertia (MOI) | The moment of inertia describes the mass distribution of the |
| | clubhead. This affects how easily the clubhead rotates in |
| | response to an off-center hit. Modern clubhead designs focus on |
| | pushing mass to the perimeter of the club to maximize the MOI. |
| | While technically this should be described using an inertial |
| | tensor, the MOI is distilled into a single number, ranging from |
| | 0.0 to 1.0, describing the overall resistance of the clubhead to |
| | twisting, with 0.5 being neutral. |
| Coefficient of restitution | According to Newton's model of collision, the coefficient of |
| (CoR) | restitution is the ratio of the final relative velocity to the initial |
| | relative velocity. For the clubface, the CoR determines the |
| | amount of “spring-like effect” produced by the clubface. Clubs |
| | with spring-like effect have faces that deform on impact with the |
| | ball. Because deforming a thin, flexible clubface is more |
| | efficient than deforming a golf ball, clubs with a high CoR |
| | generate higher launch speeds. The coefficient of restitution |
| | ranges from 0.0 to 1.0, though the USGA rules specify a |
| | maximum of 0.830 for CoR. The clubface CoR is combined |
| | with the ball CoR to determine the effective CoR for the |
| | collision. |
| Loft | This defines the angle between the clubface and vertical when |
| | the club is properly soled on a level surface. It is the primary |
| | factor in determining the launch angle. Low-lofted clubs, like |
| | drivers, produce low launch angles with relatively little spin. |
| | High-lofted clubs, like 9 irons and wedges, produce high launch |
| | angles with lots of backspin. The loft of the club is combined |
| | with the clubhead orientation to determine the surface normal for |
| | the collision. |
| Bulge | This describes the radius of curvature for a horizontal slice of the |
| | clubface. A club with lots of bulge has a relatively small radius |
| | of curvature, while a club with little bulge has a relatively large |
| | radius of curvature. A club with no bulge has a flat clubface. |
| | Bulge causes a clubface to respond differently to off-center hits. |
| | Because the normal points away from the center of the club, off- |
| | center hits are aimed to the side. On a well designed club, bulge |
| | can be used to counter the spin caused by gear effect. Bulge |
| | could be considered as adding a sort of horizontal loft. The |
| | center of clubface is assumed to be neutral. (i.e., it does not |
| | angle to either side.) This is not true for clubs designed to |
| | correct persistent shot problems, like draw clubs. |
| Roll | This describes the radius of curvature for a vertical slice of the |
| | clubface. (It's like a vertical version of bulge.) Roll affects the |
| | effective loft for off-center collisions. On a rolled clubface, the |
| | loft varies depending on the vertical distance from the center of |
| | the clubface. At the center of the clubface, the loft is the |
| | nominal loft of the club. Above the center, the loft increases, |
| | while below the center, the loft decreases. Roll serves little |
| | purpose in club design, though it is common. |
| Friction | The coefficient of friction relates the amount of horizontal force |
| | opposing sliding to the normal force between the ball and the |
| | club. The clubface has a basic value for friction, which is |
| | combined with the ball's friction and ground model's friction |
| | modifier to determine the overall friction coefficient for the |
| | collision. |

TABLE 8

| BALL | |
|---|---|
| VARIABLE | DESCRIPTION |
| Mass | The ball's mass is a major factor in determining launch |
| | speed. |
| Moment | The moment of inertia describes the relationship |
| of Inertia | between torque and rotation for the ball. In other words, |
| (MOI) | it describes how easily the ball rolls. Different types of |
| | ball construction can have different moments of inertia. |
| | This is expressed as a constant multiplier to the MOI for |
| | a solid, uniform sphere with the ball's mass. |
| Coefficient | As noted above, the coefficient of restitution describes |
| of Restitution | the ratio between the final relative velocity and the |
| (CoR) | initial relative velocity in a collision. The ball's CoR is |
| | combined with the club's CoR to determine the dynamic |
| | CoR for the collision. |
| Friction | The coefficient of friction describes the relationship |
| | between the resistive force and the normal force as the |
| | ball slides along a surface. This also depends on the |
| | construction of the ball. Balls designed for shot shaping |
| | have softer, less durable covers with higher coefficients |
| | of friction to generate higher levels of spin. The |
| | coefficient of friction really only comes into play, |
| | however, on slower swings with higher lofted clubs, as |
| | the normal force during a drive is so great that |
| | practically any coefficient of friction is sufficient to start |
| | rolling. |

In various implementations, the collision response model uses closed-form, algebraic equations to determine the collision impulse and resulting motion. Conservation of momentum and the Newtonian model of collision restitution are used to determine the collision impulse and final normal velocity. Coulomb's friction model is used to calculate the effect of tangential velocity on the ball during the collision.

The algorithm used by the collision response model follows that described by Penner, with several differences. First, the roll (vertical curvature) of the clubface is accounted for. Second, the assumption that the ball is rolling at the end of the collision is reasonable for loft angles below forty degrees, and simplifies the analysis somewhere, but is replaced in some instances. For the game, however, clubs are accurately modeled with higher degrees of loft, so the assumption that the ball is rolling at the end of the collision is replaced with a calculation to determine whether the ball is rolling or sliding at the end of the collision. Lastly, amore simplistic model of mass distribution is used.

The clubhead's impact with the ball can be modeled using existing techniques (see, e.g., Penner, A. R. “The physics of golf: The optimum loft of a driver,” American Journal of 9 (2001): 563-568 and Penner, A. R. “The physics of golf: The convex face of a driver,” American Journal of Physics 69 (2001): 1073-1081). In various implementations, the assumption that the clubhead velocity has no sideways component is modified.

Implementations of the invention and all of the functional operations described in this specification can be implemented in digital electronic circuitry, or in computer software, firmware, or hardware, including the structures disclosed in this specification and their structural equivalents, or in combinations of one or more of them. Implementations of the invention can be implemented as one or more computer program products, i.e., one or more modules of computer program instructions encoded on a computer-readable medium for execution by, or to control the operation of, data processing apparatus.

The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. For example, the actions recited in the claims can be performed in a different order and still achieve desirable results.

All articles, publications and patents referred to herein are incorporated by for all purposes.

What is claimed is:

1. A computer-implemented method, comprising:
receiving a two-dimensional photographic image of a physical terrain and a first discrete shape associated with the image, the first discrete shape associated with a location in the image and a distance value;
displaying a virtual object moving along a trajectory in the image, where a part of the two-dimensional trajectory overlaps with the location of the first discrete shape; and
obscuring some or all of the virtual object when the virtual object overlaps with the location of the first discrete shape and has a distance value greater than that of the first discrete shape.

2. The method of claim 1 where:
the image is associated with a plurality of discrete shapes, including the first discrete shape and a second discrete shape, and the first discrete shape having a greater distance value than the second discrete shape; and
displaying the virtual object moving along a trajectory in the image includes obscuring a part of a first discrete shape with the virtual object when the first discrete shape has a greater distance value than the virtual object and obscuring the virtual object when the virtual object has a distance value greater than a distance value of the second discrete shape.

3. The method of claim 1 where the image is associated with a plurality of mask layers, each mask layer having a discrete shape and where each mask layer is assigned a priority in a hierarchy.

4. The method of claim 1 where the first discrete shape represents the ground.

5. The method of claim 1, further comprising changing a display angle to display an image where the virtual object is visible.

6. The method of claim 5 where the part of the trajectory that overlaps with the first discrete shape is a landing spot.

7. The method of claim 1 where the first discrete shape is a shape of a real world object in the image.

8. The method of claim 1 where displaying comprises:
mapping a three-dimensional trajectory of the virtual object in relation to a model of the physical terrain to the two-dimensional trajectory.

9. A computer program product, encoded on a computer-readable medium, operable to cause data processing apparatus to perform operations comprising:
receiving a two-dimensional photographic image of a physical terrain and a first discrete shape associated with the image, the first discrete shape associated with a location in the image and a distance value;
displaying a virtual object moving along a trajectory in the image, where a part of the two-dimensional trajectory overlaps with the location of the first discrete shape; and
obscuring some or all of the virtual object when the virtual object overlaps with the location of the first discrete shape and has a distance value greater than that of the first discrete shape.

10. The program product of claim 9 where:
the image is associated with a plurality of discrete shapes, including the first discrete shape and a second discrete shape, and the first discrete shape having a greater distance value than the second discrete shape; and
displaying the virtual object moving along a trajectory in the image includes obscuring a part of a first discrete shape with the virtual object when the first discrete shape has a greater distance value than the virtual object and obscuring the virtual object when the virtual object has a distance value greater than a distance value of the second discrete shape.

11. The program product of claim 9 where the image is associated with a plurality of mask layers, each mask layer having a discrete shape and where each mask layer is assigned a priority in a hierarchy.

12. The program product of claim 9 where the first discrete shape represents the ground.

13. The program product of claim 9, further comprising changing a display angle to display an image where the virtual object is visible.

14. The program product of claim 13 where the part of the trajectory that overlaps with the first discrete shape is a landing spot.

15. The program product of claim 9 where the first discrete shape is a shape of a real world object in the image.

16. The program product of claim 9 where displaying comprises:
mapping a three-dimensional trajectory of the virtual object in relation to a model of the physical terrain to the two-dimensional trajectory.

17. A system comprising:
a display device;
a machine-readable storage device including a program product; and
one or more processors operable to execute the program product, interact with the display device, and perform operations comprising:
receiving a two-dimensional photographic image of a physical terrain and a first discrete shape associated with the image, the first discrete shape associated with a location in the image and a distance value;
displaying a virtual object moving along a trajectory in the image, where a part of the two-dimensional trajectory overlaps with the location of the first discrete shape; and
obscuring some or all of the virtual object when the virtual object overlaps with the location of the first discrete shape and has a distance value greater than that of the first discrete shape.

18. The system of claim 17 where:
the image is associated with a plurality of discrete shapes, including the first discrete shape and a second discrete shape, and the first discrete shape having a greater distance value than the second discrete shape; and
displaying the virtual object moving along a trajectory in the image includes obscuring a part of a first discrete shape with the virtual object when the first discrete shape has a greater distance value than the virtual object and obscuring the virtual object when the virtual object has a distance value greater than a distance value of the second discrete shape.

19. The system of claim 17 where the image is associated with a plurality of mask layers, each mask layer having a discrete shape and where each mask layer is assigned a priority in a hierarchy.

20. The system of claim 17 where the first discrete shape represents the ground.

21. The system of claim 17, further comprising changing a display angle to display an image where the virtual object is visible.

22. The system of claim 21 where the part of the trajectory that overlaps with the first discrete shape is a landing spot.

23. The system of claim 17 where the first discrete shape is a shape of a real world object in the image.

24. The system of claim 17 where displaying comprises:
mapping a three-dimensional trajectory of the virtual object in relation to a model of the physical terrain to the two-dimensional trajectory.
